(19) United States
(12) Patent Application Publication
(10) Pub. No.: US 2016/0248060 A1
(43) Pub. Date: Aug. 25, 2016

(54) BATTERY MODULE WITH ESCAPE REGION, BATTERY PACK, AND ELECTRIC VEHICLE

(71) Applicant: COVESTRO DEUTSCHLAND AG, Leverkusen (DE)

(72) Inventors: Roland BRAMBRINK, Leichlingen (DE); Ulrich GROSSER, Kürten (DE)

(21) Appl. No.: 15/026,372

(22) PCT Filed: Sep. 30, 2014
(86) PCT No.: PCT/EP2014/070859

§ 371 Date: Mar. 31, 2016

(30) Foreign Application Priority Data
Oct. 2, 2013 (EP) 13187020.6
Oct. 11, 2013 (EP) 13188325.8

(51) Int. Cl. H01M 2/10; B60L 11/18; C08L 69/00

(52) U.S. Cl. CPC H01M 2/1094; H01M 2/1077; C08L 69/00; B60L 11/1879; B60K 6/28

(57) ABSTRACT

The invention relates to a battery module (8a-f, 30, 56a-c) having a battery module housing (10a, 32), wherein the battery module housing (10a, 32) encloses a battery module compartment (12a), wherein the battery module housing (10a, 32) has on the battery module compartment side receivers (34a-b) for a specified number of battery cells (14, 36a-b), and wherein the battery module (8a-f, 30, 56a-c) has in the battery module compartment (12a), in addition to the receivers (34a-b), an escape area (16) which is of such a size and is so arranged that at least one battery cell (14, 36a-b) received in a receiver is displaceable at least partially into the escape area (16). The invention relates further to a battery pack (2, 50) having a battery pack housing (4, 52), wherein the battery pack housing (4, 52) encloses a battery pack compartment (6, 54), wherein the battery pack housing (4, 52) has on the battery pack compartment side at least one receiver for a battery module (8a-f, 30, 56a-c), and wherein the battery pack (2, 50) has a battery module (8a-f, 30, 56a-c) according to the invention received in the receiver. Finally, the invention relates also to an electric vehicle having such a battery module (8a-f, 30, 56a-c) and/or such a battery pack (2, 50).

The invention relates to a battery module having a battery module housing, wherein the battery module housing encloses a battery module compartment and wherein the battery module housing has on the battery module compartment side receivers for a specified number of battery cells. The invention relates further to a battery pack having a battery pack housing, wherein the battery pack housing encloses a battery pack compartment and wherein the battery pack housing has on the battery pack compartment side at least one receiver for a battery module. Finally, the invention relates also to an electric vehicle.

Such battery modules and battery packs are increasingly being used in electric vehicles. Such vehicles have an electric motor, which drives the vehicle either on its own or—in the case of so-called hybrid electric vehicles—in combination with a combustion engine, and a number of battery cells for storing the energy required to operate the electric motor. In order to be able to achieve maximum driving performance before the battery cells have to be recharged, a large number of battery cells with a high total capacity is conventionally integrated into the vehicle. In the present case, battery cells are understood as being in particular rechargeable battery cells, that is to say accumulators.

A specified number of battery cells are typically combined to form a battery module, in which the battery cells are surrounded by a battery module housing. A plurality of such battery modules are further typically combined to form a battery pack, which is then fitted into an electric vehicle.

The need for a large amount of storage space, or the greatest possible loading capacity, and at the same time low consumption is expressed in the case of electric vehicles in the attempt to keep the size and weight of the battery cells, or battery modules or battery packs, as small as possible. For this reason, battery cells having a high energy storage density are preferably used, such as in particular lithium ion accumulators.

However, because of their high energy density, such battery cells also give rise to a potential risk to the vehicle. In the case of damage to and/or short-circuiting of a battery cell, for example as a result of a crash, a hot flame may emerge from the battery cell. Such a flame can cause vehicle fires and even vehicle explosions. In particular, the tight packing of the battery cells within a battery module can result in the flame from one battery cell likewise damaging other battery cells, so that a chain reaction, as it were, may thereby occur, with fatal consequences for the vehicle and possibly for its occupants.

In order to reduce this potential risk from the battery cells, the battery module housing around the battery cells and the battery pack housing around the battery module housing are conventionally configured in the prior art to be sufficiently rigid and robust that the battery cells remain as undamaged as possible in the event of a crash. To that end, the battery module housing and the battery pack housing are typically manufactured from a thick steel sheet in order to protect the battery cells from a possible crash in a type of armoured cabinet, as it were.

However, these steel housings have the disadvantage of being heavy and expensive and thus reducing the economy of the electric vehicle. Furthermore, some steel housings, in particular steel housings that are made thinner for weight optimisation, have been found to be unsatisfactory for protecting the battery cells adequately in the event of a crash.

Starting from this prior art, the object underlying the present invention is to improve the operating safety of a battery module, such as, for example, a battery module for an electric vehicle, and at the same time reduce or avoid the disadvantages of a heavy and expensive steel housing.

According to the invention, this object is achieved at least partially in the case of a battery module having a battery module housing, wherein the battery module housing encloses a battery module compartment and wherein the battery module housing has on the battery module compartment side receivers for a specified number of battery cells, in that the battery module has in the battery module compartment, in addition to the receivers, an escape area which is of such a size and is so arranged that at least one battery cell received in a receiver is displaceable at least partially into the escape area.

By providing such an additional escape area, a space is provided inside the battery module compartment into which one or more battery cells can escape under the action of an external force. In this manner, the maximum force applied to individual battery cells can be reduced, so that the risk of considerable damage to the battery cells is lowered.

The inclusion of an escape area in the battery module has the advantage that an escape area for the battery cells is available independently of the conditions outside the battery module. In this manner, the battery module can be incorporated in a battery pack, or in an electric vehicle, without the need for free space around the battery module in order to allow the battery module, or battery cells arranged in the battery module, to escape.

In the battery module according to the invention, the battery module housing has on the battery module compartment side, that is to say on the inside of the battery module housing, receivers for a specified number of battery cells.

Battery modules, in particular battery modules for electric vehicles, conventionally have a specified number of battery cells which are integrated into the battery module. Typically, battery cells in a battery module are connected in series, so that the output voltage of the battery module is given by the product of the battery cell voltage and the number of battery cells connected in series. Because battery modules have to have a specified output voltage, the number of battery cells in the battery module is accordingly also specified. Correspondingly, the size of the battery module is adapted so that it is able to receive the specified number of battery cells. Typical battery modules have between 8 and 36, in particular between 12 and 36, battery cells.

A receiver for a battery cell in the battery module compartment is in particular so configured that the receiver is able to receive one battery cell. Preferably, the battery module is designed for a specific type of battery cell and the receivers are correspondingly adapted to the dimensions of this type of battery cell. For example, the battery module can be designed for battery cells of type 18650. These are substantially cylindrical battery cells having a diameter of approximately 18.6 mm and a height of approximately 65.2 mm. Receivers adapted to these battery cells can have a round receiving area, for example, the diameter of which is larger than the battery cell diameter of 18.6 mm.

In addition to battery cells of type 18650, the battery module can also be designed for other types of battery cells, for example for battery cells corresponding to one of types 10180, 10280, 10440, 14250, 14500, 14560, 15270, 16340, 17340, 17500, 17670, 18350, 18500, 19670, 25500, 26650 or 32600. To that end, the receivers can have, for example, a diameter which is larger than the diameter of the battery cell of the corresponding type.

Preferably, the receiver is so configured that a battery cell can be fixed in the receiver by a form- and/or force-based connection, in order to prevent the battery cell from slipping or sliding in normal operation. The receiver can further have connection means for the electrical connection of the battery cell, in particular for connection in series with further battery cells.

The receivers can be arranged, for example, in a plurality of rows. This enables the battery module to be of compact structural form. A particularly tight packing of the battery cells can be achieved by offsetting the receivers of adjacent rows relative to one another, preferably in a hexagonal arrangement.

The battery module according to the invention has in the battery module compartment, in addition to the receivers, an escape area which is of such a size and is so arranged that at least one battery cell received in a receiver is displaceable at least partially into the escape area.

The escape area is of such a size that at least one battery cell received in a receiver is displaceable at least partially into the escape area. The dimensioning, that is to say the size and shape, of the escape area is therefore in particular to be so chosen that at least one battery cell is able to escape into the escape area. Preferably, the escape area is sufficiently large that it can receive at least half of a battery cell, more preferably substantially all of a battery cell. The escape area is preferably in particular at least half the size of; preferably at least the same size as, the space provided by a receiver for a battery cell, that is to say the size of a receiver.

If the receivers for the battery cells are arranged in N rows, the size of the escape area preferably corresponds to at least N/2 times, more preferably at least N times, the size of a receiver. In order to allow a compact construction, the size of the escape area preferably corresponds to not more than 2N times the size of a receiver.

The escape area is further so arranged that at least one battery cell received in a receiver is displaceable at least partially into the escape area. To that end, the escape area can in particular be adjacent to at least one receiver for a battery cell. The escape area can be arranged in an edge area, in particular in a corner area, of the battery module compartment. Alternatively, the escape area can also be provided further into the battery module compartment, for example surrounded by the receivers for the battery cells.

The escape area can also have a plurality of part-areas which can be arranged in different places in the battery module compartment, whereby the totality of the part-areas together provides sufficient space so that at least one battery cell is displaceable at least partially into the escape area. If the receivers are arranged in rows, then the battery module preferably has one part-area of the escape area per row. The individual part-areas can be arranged, for example, at the edge of a row or also at an inside position in the row. By arranging the part-areas at the edge of the rows, the escape area can also serve to compensate for any movements of an adjacent battery module, for example if an adjacent battery module arranged on the corresponding edge side is deformed under the action of force.

The individual part-areas of the escape area preferably each have a size which corresponds to at least 0.5 times, preferably at least once, the size of a receiver.

In one embodiment of the battery module, the battery module housing is at least partially resilient.

This embodiment of the battery module represents a departure from the attempts hitherto made in the prior art to configure a battery module housing surrounding the battery cells ever more rigid and more solid in order to protect the battery cells from external influences. Instead, it has been found that the battery cells can be protected equally as well, or even better, by an at least partially resilient battery module housing.

In the case of a rigid battery module housing, the action of a strong local external force, as occurs in the event of a crash, for example, generally leads to local plastic deformation of the battery module housing. Because the battery cells inside the battery module housing are fixed spatially by the rigid battery module housing and the other battery cells, the battery cells arranged in the area of the deformation inside the battery module housing can be exposed to great forces and thereby damaged considerably.

By making the battery module housing at least partially resilient, the battery module housing is able to be deformed resiliently at least partially under the action of a strong local external force.

The battery module housing is able to withstand greater loads as compared with rigid and brittle battery module housings conventional in the prior art because it breaks more rarely under the action of force and thus retains its function of holding and/or protecting the battery cells.

Furthermore, the combination of an escape area in the battery module compartment with an at least partially resilient battery module housing leads to the synergistic effect that the escape of the battery cells into the escape area is facilitated by the resilient battery module housing. In particular, a spatial fixing of the battery cells arranged in the battery module housing can be eliminated at least partially by the resilient deformation of the battery module housing, so that battery cells are more easily able to escape the action of external force, in particular by utilising the escape area. For example, a resilient part-area of the battery module housing can be expanded in such a manner under the action of force that the battery module compartment in that area is enlarged and thereby facilitates the displacement of a battery cell.

Advantages comparable to those obtained in the embodiment in which the battery module housing is at least partially resilient can be achieved in a further embodiment if the battery module housing has at least partially a normalised rigidity of less than 140,000 Nmm², preferably of less than 50,000 Nmm², in particular of less than 25,000 Nmm². The normalised rigidity S is understood as being the product S=E·I of the modulus of elasticity E of the material used and the normalised area moment of inertia I, wherein I is defined by:

I=(t³·1 mm)/12,

where t is the wall thickness of the battery module housing and “1 mm” is a normalised width. As a comparison, battery module housings of the prior art manufactured from thick steel sheets have considerably higher normalised rigidities in the region of 700,000 Nmm² or even up to 2,000,000 Nmm².

A normalised rigidity of less than 140,000 Nmm², preferably less than 50,000 Nmm², in particular less than 25,000 Nmm², can be achieved in particular by using a material having a modulus of elasticity of not more than 80,000 N/mm². On the other hand, materials having a greater modulus of elasticity, for example metals such as aluminium or steel alloys, can also be used if a correspondingly thin wall thickness is provided. For example, the battery module housing can be formed partially or substantially wholly of thin metal sheets, in particular aluminium or steel sheets, having a wall thickness in the range of from 0.5 mm to 1.5 mm.

In order to achieve the above-described purpose, at least one side wall of the battery module housing, preferably a plurality of side walls or all the side walls and in particular substantially the entire battery module housing, including the cover and the base, can be resilient and/or have an above-described flexural rigidity.

Part-areas of the battery module housing that are necessarily non-resilient or flexurally rigid, for example for the electrical connection of the battery cells or for fixing the battery module housing in a vehicle or in a battery pack, are generally not detrimental to the above-described effect and are included in a battery module housing that is partially or substantially resilient or in a battery module housing that partially or substantially has an above-described flexural rigidity.

A resilient part-area of the battery module housing is understood in particular as meaning that the part-area in question has a modulus of elasticity of not more than 80,000 N/mm², in particular of not more than 30,000 N/mm². Crash simulations have shown that such a modulus of elasticity is suitable for allowing battery cells to escape in the event of a crash. On the other hand, the part-area preferably has a modulus of elasticity of at least 750 N/mm², preferably of at least 1000 N/mm², in particular of at least 2000 N/mm², in order to ensure that the battery cells are housed securely and firmly in normal operation, that is to say without the action of great high external forces as in the event of a crash, and to reduce as far as possible or avoid the displacement of the battery cells in the battery cell compartment.

The above-described moduli of elasticity can be achieved in particular by choosing a corresponding material. In particular, moduli of elasticity in the range of from 2000 to 3000 N/mm², in particular from 2200 to 2800 N/mm², can be achieved with polycarbonates. With fibre-reinforced polycarbonates, moduli of elasticity in the range of from 10,000 to 30,000 N/mm², in particular from 25,000 to 30,000 N/mm², can in particular be achieved. With polypropylenes, moduli of elasticity in the range of from 800 to 900 N/mm² can in particular be achieved, and in the case of thermoplastic injection-moulded parts, moduli of elasticity in the range of from 1500 to 8000 N/mm² can in particular be achieved.

Fibre-reinforced materials include in particular long-fibre-reinforced and endless-fibre-reinforced materials based on thermosetting materials and based on thermoplastics, referred to as fibre composites or composite sheet hereinbelow.

The fibre composite has at least one fibre ply of a fibre material. Such a fibre ply is understood as being a sheet-form ply which is formed by fibres arranged substantially in a plane. The fibres can be connected together by their position relative to one another, for example by a fabric-like arrangement of the fibres. The fibre ply can further comprise an amount of resin or another adhesive in order to connect the fibres together. Alternatively, the fibres can also be unconnected. This is understood as meaning that the fibres can be separated from one another without the use of an appreciable force. The fibre ply can also comprise a combination of connected and unconnected fibres.

The at least one fibre ply is embedded in a matrix based on a thermoplastic plastic. This is understood as meaning that the fibre ply is surrounded at least on one side, preferably on both sides, by a thermoplastic plastic. The edge of the matrix of the thermoplastic plastic forms in particular the outside surface of the component or semi-finished product consisting of the fibre composite.

The number of fibre plies is in principle not limited in the fibre composite. It is therefore also possible to arrange two or more fibre plies one above another. Two fibre plies located one above the other can each be embedded in the matrix individually, so that they are both surrounded on both sides by the matrix. Furthermore, two or more fibre plies can also be located immediately on top of one another, so that they are surrounded as a whole by the matrix. In this case, these two or more fibre plies can also be regarded as one thick fibre ply.

The matrix of the fibre composite is preferably a thermoplastic plastic. Suitable thermoplastic plastics are polycarbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copoly-acrylates and poly- or copoly-methacrylate such as, for example, poly- or copoly-methyl methacrylates (such as PMMA), polyamides (preferably polyamide 6 (PA6) and polyamide 6.6 (PA6.6)), as well as copolymers with styrene such as, for example, transparent polystyrene acrylonitrile (PSAN), thermoplastic polyurethanes, polymers based on cyclic olefins (e.g. TOPAS®, a commercial product from Ticona), or mixtures of the mentioned polymers, as well as polycarbonate blends with olefinic copolymers or graft polymers, such as, for example, styrene/acrylonitrile copolymers and optionally further of the above-mentioned polymers. In a further embodiment, the polycarbonate compositions mentioned below are suitable as the matrix for the fibre composite layer.

In one embodiment of the fibre composite, the content by volume of fibre material in the total volume of the fibre composite is generally in the range of from 30 to 60 vol. %, preferably in the range of from 40 to 55 vol. %.

For the part-area of the battery module housing, there is further preferably used a material having an elongation at break according to DIN ISO 527-1,-2 of at least 2%, preferably of at least 15%, in particular of at least 30%.

In one embodiment of the battery module, a resilient element is arranged in the escape area. By means of this resilient element, battery cells arranged in the receivers can be prevented from being displaced into the escape area in normal operation. In particular, the resilient element can be so configured and arranged for that purpose that a holding force is exerted by the resilient element on at least one battery cell arranged in a receiver. If, for example, a spring element such as a plastics or metal spring element is used as the resilient element, the spring element is able to hold one or more battery cells in position in normal operation. However, the resilient element can also be in the form of resilient foam, for example in the form of resilient plastics foam.

Preferably, the resilient element extends over the escape area in such a manner that access to the escape area is blocked in normal operation. For example, the resilient element can to that end fill at least half, preferably substantially all, of the escape area, in particular when the resilient element is a resilient foam. Battery cells arranged in the receivers can thereby easily be prevented from being displaced into the escape area in normal operation.

In order reliably to prevent battery cells from being displaced into the escape area in normal operation, the resilient element is preferably so configured that, when compressed by not more than 10% of its original extent, it effects a restoring force of at least 50 N directed against the compression. In the case of a spring, this can be achieved by an appropriate choice of spring constant. If, for example, a spring having a length of 20 mm and a spring constant of 25,000 N/m is used, compression of the spring by 10%, that is to say by 2 mm to 18 mm, leads to a restoring force of 25,000 N/m·2 mm=50 N.

As a result of the above-described choice of the resilient element, forces that occur during normal operation, such as, for example, during full braking, lead at most to slight compression of the resilient element, so that the battery cells continue to be held in the receivers.

Owing to its resilience, the resilient element can be compressed if the battery module is acted upon by great forces, as in the event of a crash, so that the escape area is freed for the possible displacement of one or more battery cells. In order to ensure that the escape area is freed by compression of the resilient element, the resilient element is preferably so configured that, when it is compressed by at least 50% of its original extent, it effects a restoring force directed against the compression of not more than 100 N.

In a further embodiment of the battery module, the resilient element is connected to the battery module housing by a form-, force- and/or material-based connection. The resilient element can thereby be prevented from slipping before the battery cells are inserted into the battery module compartment, and insertion can accordingly be facilitated. Furthermore, the resilient element is thus held in a specified and optionally advantageous position in the battery module.

The resilient element can be adhesively bonded into the battery module, for example, or interlocked therewith by locking means. Furthermore, the resilient element can also be of such a size that it is held by a form- and/or force-based connection through the cover and the base of the battery module housing. The form-, force- and/or material-based connection can further preferably be configured to be sufficiently weak that it is released under the action of a great force, as in the event of a crash, and the resilient element is able to be moved inside the battery module compartment.

In a further embodiment of the battery module, the resilient element is in one piece at least with a part of the battery module housing. For example, the resilient element can be provided during the production of the battery module housing, for example by being produced by injection moulding together with the battery module housing and thus being injection moulded therewith. The resilient element can accordingly be produced inexpensively and provided in the battery module compartment without an additional mounting step.

Alternatively, it is also possible to provide a separate resilient element. This has the advantage that a different material can be used for the resilient element than for the battery module housing, so that the properties of the resilient element can be adjusted independently of the properties of the battery module housing.

In a further embodiment of the battery module, at least one receiver for a battery cell is formed at least partially by a depression in the battery module housing. By means of a depression in the battery module housing, in particular in the base and/or in the cover of the battery module housing, a battery cell can be fixed securely in the battery module compartment for normal operation. The dimensions of the depression are in particular adapted to the battery cell that is to be received, so that the battery cell can be received in the depression. Preferably, the battery module housing substantially has at least one such depression for all the receivers.

The depressions are preferably configured to be sufficiently shallow that the battery cells are able to come out of the depressions under the action of a great force, as in the event of a crash, and are thus displaceable inside the battery module compartment. Preferably, the depth of the depressions is from 1 to 3 mm. The depressions can have bevelled portions at the edge in order to facilitate the displacement of the battery cells from the depressions in the case of the action of a great force.

In a further preferred embodiment of the battery module, at least one receiver for a battery cell is formed at least partially by a collar element fixed to the battery module housing. The collar element is preferably configured for the force- and/or form-based fixing of a battery cell received in the receiver. Preferably, such a collar element is provided on the base and/or on the cover of the battery module housing. Furthermore, preferably at least one such collar element is provided substantially for all the receivers. In addition or alternatively, in a further embodiment of the battery module a holding element can be arranged on at least one receiver for holding a battery cell in the receiver in normal operation.

The collar element, or the holding element, are preferably in such a form that they fold down, break off or otherwise release a battery cell arranged in the receiver under the action of a great force, as in the event of a crash, so that the battery cell is displaceable in the battery compartment. To that end, the collar element can consist, for example, of a plurality of segments, so that individual segments of the collar element are able to fold down outwards. Preferably, the collar element, or the holding element, are in such a form that they release a battery cell arranged in the receiver when they are acted upon by a force of more than 100 N, preferably of more than 75 N.

In a further embodiment of the battery module, the battery module housing and/or a resilient element arranged in the escape area comprises a flame-retardant active ingredient, in particular a flame-retardant plastic.

In the present case, a flame-retardant material, in particular a flame-retardant plastic, is understood as being a material which is able to melt and optionally also burn as long as a flame is acting upon it but does not continue to burn when the flame has been extinguished and thus prevents a fire from spreading. In the present case, a flame-retardant material is understood as being in particular a material which meets the requirements of the UL 94-V (rod) test. The UL 94-V (rod) test is a test of the Underwriters Laboratories from the UL 94 specification (“Tests for Flammability of Plastic Materials for Parts in Devices and Applications”). The flame-retardant material preferably meets classification V-2, preferably classification V-1, in particular classification V-0 in the UL 94-V (rod) test.

Preferably, the material, in particular the flame-retardant material, contained in the safety wall portion meets classification 5VB in the UL 94-5VB (sheet) test with formation of a burn hole.

The above-mentioned UL tests are correspondingly also to be found in DIN EN 60695-11-10 and DIN EN 60695-11-20.

In a further embodiment of the battery module, the battery module housing comprises a polycarbonate material. The battery module housing can, for example, be based partially or substantially wholly on a polycarbonate material.

Polycarbonate materials are distinguished by good resilience and high strength, in particular also at low temperatures down to −30° C., which may well occur in the case of use in electric vehicles. Furthermore, polycarbonate materials can be provided with good flame-retardant properties.

Suitable polycarbonate materials in the present case are in particular polycarbonate compositions comprising
A) from 70.0 to 90.0 parts by weight, preferably from 75.0 to 88.0 parts by weight, particularly preferably from 77.0 to 85.0 parts by weight (based on the sum of the parts by weight of components A+B+C) of linear and/or branched aromatic polycarbonate and/or aromatic polyester carbonate,
B) from 6.0 to 15.0 parts by weight, preferably from 7.0 to 13.0 parts by weight, particularly preferably from 9.0 to 11.0 parts by weight (based on the sum of the parts by weight of components A+B+C) of at least one graft polymer having
   B.1) from 5 to 40 wt. %, preferably from 5 to 30 wt. %, particularly preferably from 10 to 20 wt. % (in each case based on the graft polymer B) of a shell of at least one vinyl monomer, and
   B.2) from 95 to 60 wt. %, preferably from 95 to 70 wt. %, particularly preferably from 80 to 90 wt. % (in each case based on the graft polymer B) of one or more graft bases of silicone-acrylate composite rubber,
C) from 2.0 to 15.0 parts by weight, preferably from 3.0 to 13.0 parts by weight, particularly preferably from 4.0 to 11.0 parts by weight (based on the sum of the parts by weight of components A+B+C) of phosphorus compounds selected from the groups of the monomeric and oligomeric phosphoric and phosphonic acid esters, phosphonate amines, phosphazenes and phosphinates, it also being possible for mixtures of a plurality of components selected from one or various of these groups to be used as flame retardants,
D) from 0 to 3.0 parts by weight, preferably from 0.01 to 1.00 part by weight, particularly preferably from 0.1 to 0.6 part by weight (based on the sum of the parts by weight of components A+B+C) of antidripping agents,
E) from 0 to 3.0 parts by weight, preferably from 0 to 1.0 part by weight (based on the sum of the parts by weight of components A+B+C) of thermoplastic vinyl (co)polymer (E.1) and/or polyalkylene terephthalate (E.2), the composition is particularly preferably free of thermoplastic vinyl (co)polymers (E.1) and/or polyalkylene terephthalates (E.2), and
F) from 0 to 20.0 parts by weight, preferably from 0.1 to 10.0 parts by weight, particularly preferably from 0.2 to 5.0 parts by weight (based on the sum of the parts by weight of components A+B+C) of further additives,
   wherein the compositions are preferably free of rubber-free polyalkyl (alkyl)acrylate, and wherein all part by weight data in the present application are so normalised that the sum of the parts by weight of components A+B+C in the composition is 100.

Further suitable polycarbonate materials in the present case are in particular polycarbonate compositions comprising
A) from 70.0 to 90.0 parts by weight, preferably from 75.0 to 88.0 parts by weight, particularly preferably from 77.0 to 85.0 parts by weight (based on the sum of the parts by weight of components A+B*+C) of linear and/or branched aromatic polycarbonate and/or aromatic polyester carbonate,
B*) from 6.0 to 15.0 parts by weight, preferably from 7.0 to 13.0 parts by weight, particularly preferably from 9.0 to 11.0 parts by weight (based on the sum of the parts by weight of components A+B*+C) of at least one graft polymer having
   B*.1) from 5 to 95 parts by weight, preferably from 30 to 80 parts by weight, of a mixture of
      B*.1.1) from 50 to 95 parts by weight of styrene, t-methylstyrene, styrene methyl-substituted on the ring, C₁-C₈-alkyl methacrylate, in particular methyl methacrylate, C₁-C₈-alkyl acrylate, in particular methyl acrylate, or mixtures of these compounds, and
      B*.1.2) from 5 to 50 parts by weight of acrylonitrile, methacrylonitrile, C₁-C₈-alkyl methacrylates, in particular methyl methacrylate, C₁-C₈-alkyl acrylate, in particular methyl acrylate, maleic anhydride, C₁-C₄-alkyl- or -phenyl-N-substituted maleimides, or mixtures of these compounds, on
   B*.2) from 5 to 95 parts by weight, preferably from 20 to 70 parts by weight, of a rubber-containing graft base based on butadiene or acrylate,
C) from 2.0 to 15.0 parts by weight, preferably from 3.0 to 13.0 parts by weight, particularly preferably from 4.0 to 11.0 parts by weight (based on the sum of the parts by weight of components A+B*+C) of phosphorus compounds selected from the groups of the monomeric and oligomeric phosphoric and phosphonic acid esters, phosphonate amines, phosphazenes and phosphinates, it also being possible for mixtures of a plurality of components selected from one or various of these groups to be used as flame retardants,
D) from 0 to 3.0 parts by weight, preferably from 0.01 to 1.00 part by weight, particularly preferably from 0.1 to 0.6 part by weight (based on the sum of the parts by weight of components A+B*+C) of antidripping agents,
E) from 0 to 3.0 parts by weight, preferably from 0 to 1.0 part by weight (based on the sum of the parts by weight of components A+B*+C) of thermoplastic vinyl (co)polymer (E.1) and/or polyalkylene terephthalate (E.2), the composition is particularly preferably free of thermoplastic vinyl (co)polymers (E.1) and/or polyalkylene ter-phthalates (E.2), and
F) from 0 to 20.0 parts by weight, preferably from 0.1 to 10.0 parts by weight, particularly preferably from 0.2 to 5.0 parts by weight (based on the sum of the parts by weight of components A+B*+C) of further additives,
   wherein the compositions are preferably free of rubber-free polyalkyl (alkyl)acrylate, and wherein all part by weight data in the present application are so normalised that the sum of the parts by weight of components A+B*+C in the composition is 100.

The individual components of the above-described polycarbonate compositions are described in greater detail in the following:

### Component A

Suitable aromatic polycarbonates and/or aromatic polyester carbonates according to component A are known in the literature or can be prepared by processes known in the literature (for the preparation of aromatic polycarbonates see, for example, Schnell, “Chemistry and Physics of Polycarbonates”, Interacience Publishers, 1964 and also DE-AS 1 495 626, DE-A 2 232 877, DE-A 2 703 376, DE-A 2 714 544, DE-A 3 000 610, DE-A 3 832 396; for the preparation of aromatic polyester carbonates see, for example, DE-A 3 077 934).

The preparation of aromatic polycarbonates is carried out, for example, by reacting diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents having a functionality of three or more than three, for example triphenols or tetraphenols. Preparation by a melt polymerisation process by reacting diphenols with, for example, diphenyl carbonate is also possible.

Diphenols for the preparation of the aromatic polycarbonates and/or aromatic polyester carbonates are preferably those of formula (I)

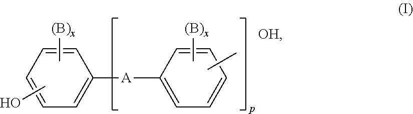

wherein
A denotes a single bond, C₁- to C₅-alkylene, C₂- to C₅-alkylidene, C₅ to C₆-cycloalkylidene, —O—, —SO—, —CO—, —S—, —SO₂—, C₆- to C₁₂-arylene, to which further rings optionally containing heteroatoms can be fused,
   or a radical of formula (II) or (III)

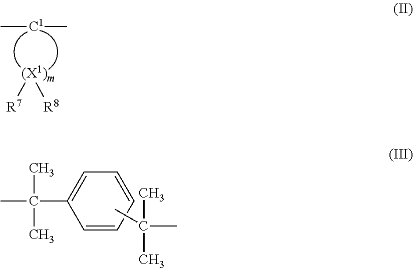

B in each case denotes C₁- to C₁₂-alkyl, preferably methyl, halogen, preferably chlorine and/or bromine,
x in each case independently of one another denotes 0, 1 or 2,
p are 1 or 0, and
R⁷ and R⁸ can be chosen individually for each X¹ and, independently of one another, are hydrogen or C₁ to C₆-alkyl, preferably hydrogen, methyl or ethyl,
X¹ denotes carbon and
m denotes an integer from 4 to 7, preferably 4 or 5, with the proviso that on at least one atom X¹, R⁷ and R⁸ are simultaneously alkyl.

Preferred diphenols are hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl) ethers, bis-(hydroxy-phenyl) sulfoxides, bis-(hydroxyphenyl) ketones, bis-(hydroxyphenyl)-sulfones and α,α-bis-(hydroxyphenyl)-diisopropylbenzenes and derivatives thereof brominated and/or chlorinated on the ring.

Particularly preferred diphenols are 4,4′-dihydroxydiphenyl, bisphenol A, 2,4-bis(4-hydroxy-phenyl)-2-methylbutane, 1,1-bis-(4-hydroxyphenyl)-cyclohexane, 1,1-bis-(4-hydroxyphenyl)-3.3.5-trimethylcyclohexane, 4,4′-dihydroxydiphenyl sulfide, 4,4′-dihydroxydiphenylsulfone and di- and tetra-brominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. 2,2-Bis-(4-hydroxyphenyl)-propane (bisphenol A) is particularly preferred.

The diphenols can be used individually or in the form of arbitrary mixtures. The diphenols are known in the literature or obtainable by processes known in the literature.

Chain terminators suitable for the preparation of the thermoplastic, aromatic polycarbonates are, for example, phenol, p-chlorophenol, p-tert-butylphenol or 2,4,6-tribromophenol, but also long-chain alkylphenols, such as 4-[2-(2,4,4-trimethylpentyl)]-phenol, 4-(1,3-tetramethylbutyl)-phenol according to DE-A 2 842 005 or monoalkylphenol or dialkylphenols having a total of from 8 to 20 carbon atoms in the alkyl substituents, such as 3,5-di-tert-butylphenol, p-isooctylphenol, p-tert-octylphenol, p-dodecylphenol and 2-(3,5-dimethylhcptyl)-phenol and 4-(3,5-dimethylheptyl)-phenol. The amount of chain terminators to be used is generally from 0.5 mol % to 10 mol %, based on the molar sum of the diphenols used in a particular case.

The thermoplastic, aromatic polycarbonates have mean weight-average molecular weights (M_{w}, measured, for example, by GPC, ultracentrifuge or scattered light measurement) of from 10,000 to 200,000 g/mol, preferably from 15,000 to 80,000 g/mol, particularly preferably from 24,000 to 32,000 g/mol.

The thermoplastic, aromatic polycarbonates can be branched in known manner, preferably by the incorporation of from 0.05 to 2.0 mol %, based on the sum of the diphenols used, of compounds having a functionality of three or more than three, for example those having three or more phenolic groups.

Both homopolycarbonates and copolycarbonates are suitable. For the preparation of the copolycarbonates according to component A it is also possible to use from 1.0 to 25.0 wt. %, preferably from 2.5 to 25.0 wt. %, based on the total amount of diphenols to be used, of polydiorganosiloxanes having hydroxyaryloxy end groups. These are known (U.S. Pat. No. 3,419,634) and can be prepared by processes known in the literature. The preparation of copolycarbonates comprising polydiorganosiloxanes is described in DE-A 3 334 782.

In addition to the bisphenol A homopolycarbonates, preferred polycarbonates are the copolycarbonates of bisphenol A with up to 15 mol %, based on the molar sums of diphenols, of diphenols other than those mentioned as being preferred or particularly preferred, in particular 2,2-bis(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and teephthalic acid in a ratio of from 1:20 to 20:1.

In the preparation of polyester carbonates, a carbonic acid halide, preferably phosgene, is additionally used concomitantly as bifunctional acid derivative.

There come into consideration as chain terminators for the preparation of the aromatic polyester carbonates, in addition to the monophenols already mentioned, also their chlorocarbonic acid esters as well as the acid chlorides of aromatic monocarboxylic acids, which can optionally be substituted by C₁- to C₂₂-alkyl groups or by halogen atoms, as well as aliphatic C₂- to C₂₂-monocarboxylic acid chlorides.

The amount of chain terminators is in each case from 0.1 to 10.0 mol %, based in the case of phenolic chain terminators on moles of diphenol and in the case of monocarboxylic acid chloride chain terminators on moles of dicarboxylic acid dichloride.

The aromatic polyester carbonates can also comprise aromatic hydroxycarboxylic acids incorporated therein. The aromatic polyester carbonates can be both linear and branched in a known manner (see in this connection DE-A 2 940 024 and DE-A 3 007 934).

There can be used as branching agents, for example, carboxylic acid chlorides having a functionality of three or more, such as trimesic acid trichloride, cyanuric acid trichloride, 3,3′-,4,4′-benzophenonetetracarboxylic acid tetrachloride, 1,4,5,8-naphthalenetetracarboxylic acid tetrachloride or pyromellitic acid tetrachloride, in amounts of from 0.01 to 1.0 mol % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4-6-tri-(4-hydroxyphenyl)-heptane, 1,3,5-tri-(4-hydroxyphenyl)-benzene, 1,1,l-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytri-phenyl)-methyl]-benzene, in amounts of from 0.01 to 1.00 mol %, based on diphenols used. Phenolic branching agents can be placed in a reaction vessel with the diphenols, acid chloride branching agents can be introduced together with the acid dichlorides.

In the thermoplastic, aromatic polyester carbonates, the amount of carbonate structural units can vary as desired. The amount of carbonate groups is preferably up to 100 mol %, in particular up to 80 mol %, particularly preferably up to 50 mol %, based on the sum of ester groups and carbonate groups. Both the ester component and the carbonate component of the aromatic polyester carbonates can be present in the polycondensation product in the form of blocks or in randomly distributed form.

The relative solution viscosity (ηᵣₑₗ) of the aromatic polycarbonates and polyester carbonates is in the range of from 1.18 to 1.40, preferably from 1.20 to 1.32 (measured on solutions of 0.5 g of polycarbonate or polyester carbonate in 100 ml of methylene chloride solution at 25° C.).

The thermoplastic, aromatic polycarbonates and polyester carbonates can be used on their own or in an arbitrary mixture.

### Component B

The graft polymers B are prepared by radical polymerisation, for example by emulsion, suspension, solution or mass polymerisation, preferably by emulsion polymerisation.

Suitable monomers B.1 are vinyl monomers such as vinyl aromatic compounds and/or vinyl aromatic compounds substituted on the ring (such as styrene, α-methylstyrene, p-methylstyrene, p-chlorostyrene), methacrylic acid (C₁-C₈)-alkyl esters (such as methyl methacrylate, ethyl methacrylate, 2-ethylhexyl methacrylate, allyl methacrylate), acrylic acid (C₁-C₈)-alkyl esters (such as methyl acrylate, ethyl acrylate, n-butyl acrylate, tert-butyl acrylate), organic acids (such as acrylic acid, methacrylic acid) and/or vinyl cyanides (such as acrylonitrile and methacrylonitrile) and/or derivatives (such as anhydrides and imides) of unsaturated carboxylic acids (for example maleic anhydride and N-phenyl-maleimide). These vinyl monomers can be used on their own or in mixtures of at least two monomers.

Preferred monomers B.1 are selected from at least one of the monomers styrene, α-methylstyrene, methyl methacrylate, n-butyl acrylate and acrylonitrile. Methyl methacrylate is particularly preferably used as the monomer B.1.

The glass transition temperature of the graft base B.2 is <10° C., preferably <0° C., particularly preferably <-20° C. The graft base B.2 generally has a mean particle size (d₅₀ value) of from 0.05 to 10 μm, preferably from 0.06 to 5 μm, particularly preferably from 0.08 to 1 μm.

The glass transition temperature is determined by means of differential scanning calorimetry (DSC) according to standard DIN EN 61006 at a heating rate of 10 K/min with definition of the T_{g} as the mid-point temperature (tangent method).

The mean particle size d₅₀ is the diameter above and below which in each case 50 wt. % of the particles lie. It can be determined by means of ultracentrifuge measurement (W. Scholtan, H. Lange, Kolloid-Z. und Z. Polymere 250 (1972), 782-796).

Silicono-acrylate composite rubber is used as the graft base B.2. Such silicone-acrylate composite rubbers are preferably composite rubbers having graft-active sites comprising from 10 to 90 wt. %, preferably from 30 to 85 wt. %, silicone rubber component and from 90 to 10 wt. %, preferably from 70 to 15 wt. %, polyalkyl (meth)acrylate rubber component, wherein the two mentioned rubber components interpenetrate in the composite rubber so that they cannot substantially be separated from one another.

If the proportion of the silicone rubber component in the composite rubber is too high, the finished resin compositions have disadvantageous surface properties and impaired dyeability. If, on the other hand, the proportion of the polyalkyl (meth)acrylate rubber component in the composite rubber is too high, the impact strength of the finished resin composition is adversely affected.

Silicone-acrylate composite rubbers are known and are described, for example, in U.S. Pat. No. 5,807,914, EP 430134 and U.S. Pat. No. 4,888,388.

Suitable silicone rubber components B.2.1 of the silicone-acrylate composite rubbers according to B.2 are silicone rubbers having graft-active sites, the preparation method of which is described, for example, in U.S. Pat. No. 2,891,920, U.S. Pat. No. 3,294,725, DE-OS 3 631 540, EP 249964, EP 430134 and U.S. Pat. No. 4,888,388.

The silicone rubber according to B.2.1 is preferably prepared by emulsion polymerisation, in which siloxane monomer structural units, crosslinking or branching agents (IV) and optionally grafting agents (V) are used.

As siloxane monomer structural units there are used, for example and preferably, dimethylsiloxane or cyclic organosiloxanes having at least 3 ring members, preferably from 3 to 6 ring members, such as, for example and preferably, hexamethylcyclotrisiloxane, octamethylcyclotetrasiloxane, decamethylcyclopentasiloxane, dodecamethylcyclohexasiloxane, trimethyl-triphenyl-cyclotri-siloxanes, tetramethyl-tetraphenyl-cyclotetrasiloxanes, octaphenylcyclotetrasiloxane.

The organosiloxane monomers can be used on their own or in the form of mixtures with 2 or more monomers. The silicone rubber preferably comprises not less than 50 wt. % and particularly preferably not less than 60 wt. % organosiloxane, based on the total weight of the silicone rubber component.

As crosslinking or branching agents (IV) there are preferably used silane-based crosslinking agents having a functionality of 3 or 4, particularly preferably 4. Preferred examples which may be mentioned are: trimethoxymethylsilane, triethoxyphenylsilane, tetramethoxysilane, tetraethoxy-silane, tetra-n-propoxysilane and tetrabutoxysilane. The crosslinking agent can be used on its own or in a mixture of two or more. Tetraethoxysilane is particularly preferrred.

The crosslinking agent is used in an amount in the range of from 0.1 to 40.0 wt. %, based on the total weight of the silicone rubber component. The amount of crosslinking agent is so chosen that the degree of swelling of the silicone rubber, measured in toluene, is between 3 and 30, preferably between 3 and 25, and particularly preferably between 3 and 15. The degree of swelling is defined as the weight ratio between the amount of toluene absorbed by the silicone rubber when it is saturated with toluene at 25° C., and the amount of silicone rubber in the dried state. The determination of the degree of swelling is described in detail in EP 249964.

If the degree of swelling is less than 3, that is to say if the content of crosslinking agent is too high, the silicone rubber does not exhibit sufficient rubber elasticity. If the swelling index is greater than 30, the silicone rubber cannot form a domain structure in the matrix polymer and therefore also cannot improve impact strength, the effect would then be similar to simply adding polydimethylsiloxane.

Tetrafunctional crosslinking agents are preferred over trifunctional crosslinking agents because the degree of swelling is then easier to control within the above-described limits.

Suitable grafting agents (V) are compounds that are capable of forming structures of the following formulae:

CH₂═C(R⁹)—COO—(CH₂)ₚ—SiR¹⁰ₙO_{(3-n)/2} (V-1)

CH₂═CH—SiR¹⁰ₙO_{(3-n)/2} (V-2) or

HS—(CH₂)ₚ—SIR¹⁰ₙO_{(3-n)/2} (V-3),

wherein
R⁹ represents hydrogen or methyl,
R¹⁰ represents C₁-C₄-alkyl, preferably methyl, ethyl or propyl, or phenyl,
n represents 0, 1 or 2, and
p represents an integer from 1 to 6.

Acryloyl- or methacryloyl-oxysilanes are particularly suitable for forming the above-mentioned structure (V-1) and have a high grafting efficiency. Effective formation of the graft chains is thereby ensured, and accordingly the impact strength of the resulting resin composition is increased.

There may be mentioned by way of preferred examples: β-methacryloyloxy-ethyldimethoxymethyl-silane, γ-methacryloyloxy-propylmethoxydimethyl-silane, γ-methacryloyl-oxy-propyldimethoxymethyl-silane, γ-methacryloyloxy-propyltrimethoxy-silane, γ-methacryloyl-oxy-propylethoxydiethyl-silane, γ-methacryloyloxy-propyldiethoxymethyl-silane, δ-methacryloyl-oxy-butyldiethoxymethyl-silane or mixtures thereof.

From 0 to 20 wt. % of grafting agent are preferably used, based on the total weight of the silicone rubber.

The silicone rubber can be prepared by emulsion polymerisation, as described, for example, in U.S. Pat. No. 2,891,920 and U.S. Pat. No. 3,294,725. The silicone rubber is thereby obtained in the form of an aqueous latex. To that end, a mixture comprising organosiloxane, crosslinking agent and optionally grafting agent is mixed with water under shear, for example by means of a homogeniser, in the presence of an emulsifier based on sulfonic acid, such as, for example, alkylbenzenesulfonic acid or alkylsulfonic acid, the mixture polymerising completely to form the silicone rubber latex. An alkylbenzenesulfonic acid is particularly suitable because it acts not only as an emulsifier but also as a polymerisation initiator. In this case, a combination of sulfonic acid with a metal salt of an alkylbenzenesulfonic acid or with a metal salt of an alkylsulfonic acid is advantageous, because the polymer is thereby stabilised during the subsequent graft polymerisation.

After the polymerisation, the reaction is terminated by neutralising the reaction mixture by adding an aqueous alkaline solution, for example by adding an aqueous sodium hydroxide, potassium hydroxide or sodium carbonate solution.

Suitable polyalkyl (meth)acrylate rubber components B.2.2 of the silicone-acrylate composite rubbers according to B.2 can be prepared from methacrylic acid alkyl esters and/or acrylic acid alkyl esters, a crosslinking agent (IV) and a grafting agent (V). Examples of preferred methacrylic acid alkyl esters and/or acrylic acid alkyl esters are the C₁- to C₈-alkyl esters, for example methyl, ethyl, n-butyl, tert-butyl, n-propyl, n-hexyl, n-octyl, n-lauryl and 2-ethylhexyl esters; haloalkyl esters, preferably halo-C₁-C₈-alkyl esters, such as chloroethyl acrylate, as well as mixtures of these monomers. n-Butyl acrylate is particularly preferred.

As crosslinking agents (IV) for the polyalkyl (meth)acrylate rubber component of the silicone-acrylate rubber there can be used monomers having more than one polymerisable double bond. Preferred examples of crosslinking monomers are esters of unsaturated monocarboxylic acids having from 3 to 8 carbon atoms and unsaturated monohydric alcohols having from 3 to 12 carbon atoms, or saturated polyols having from 2 to 4 OH groups and from 2 to 20 carbon atoms, such as ethylene glycol dimethacrylate, propylene glycol dimethacrylate, 1,3-butylene glycol dimethacrylate and 1,4-butylene glycol dimethacrylate. The crosslinking agents can be used on their own or in mixtures of at least two crosslinking agents.

Examples of preferred grafting agents (V) are allyl methacrylate, triallyl cyanurate, triallyl isocyanurate or mixtures thereof. Allyl methacrylate can also be used as the crosslinking agent (IV). The grafting agents can be used on their own or in mixtures of at least two grafting agents.

The amount of crosslinking agent (IV) and grafting agent (V) is from 0.1 to 20 wt. %, based on the total weight of the polyalkyl (meth)acrylate rubber component of the silicone-acrylate rubber.

The silicone-acrylate composite rubber is produced by first preparing the silicone rubber according to B.2.1 as an aqueous latex. This latex is then enriched with the methacrylic acid alkyl esters and/or acrylic acid alkyl esters that are to be used, the crosslinking agent (IV) and the grafting agent (V), and polymerisation is carried out. Preference is given to a radically initiated emulsion polymerisation, for example by a peroxide, azo or redox initiator. Particular preference is given to the use of a redox initiator system, especially a sulfoxylate initiator system prepared by combining iron sulfate, disodium ethylenediamine tetraacetate, rongalite and hydroperoxide.

The grafting agent (V) used in the production of the silicone rubber results in the polyalkyl (meth)acrylate rubber component being bonded covalently to the silicone rubber component. In the polymerisation, the two rubber components interpenetrate and thus form the composite rubber, which can no longer be separated into its constituents of silicone rubber component and polyalkyl (meth)acrylate rubber component after the polymerisation.

For the production of the silicone-acrylate composite graft rubbers B mentioned as component B), the monomers B.1 are grafted onto the rubber base B.2.

The polymerisation methods described in EP 249964, EP 430134 and U.S. Pat. No. 4,888,388 can be used, for example.

For example, the graft polymerisation is carried out by the following polymerisation method: In a single- or multi-stage radically initiated emulsion polymerisation, the desired vinyl monomers B.1 are polymerised onto the graft base, which is in the form of an aqueous latex. The grafting efficiency should be as high as possible and is preferably greater than or equal to 10%. The grafting efficiency depends substantially on the grafting agent (V) used. After polymerisation to the silicone (acrylate) graft rubber, the aqueous latex is placed in hot water in which metal salts, such as, for example, calcium chloride or magnesium sulfate, have previously been dissolved. The silicone (acrylate) graft rubber thereby coagulates and can then be separated off.

The methacrylic acid alkyl ester and acrylic acid alkyl ester graft rubbers mentioned as component B) are available commercially. Examples which may be mentioned are: Metablen® SX 005, Metablen® S-2030 and Metablen® SRK 200 from Mitsubishi Rayon Co. Ltd.

### Component B*

The graft polymers B* are prepared by radical polymerisation, for example by emulsion, suspension, solution or mass polymerisation, preferably by emulsion polymerisation.

The graft polymers B* comprise, for example, graft polymers having rubber-elastic properties, which are obtainable substantially from at least 2 of the following monomers: chloroprene, 1,3-butadiene, isoprene, styrene, acrylonitrile, ethylene, propylene, vinyl acetate and (meth)acrylic acid esters having from 1 to 18 carbon atoms in the alcohol component; that is to say polymers as are described, for example, in “Methoden der Organischen Chemie” (Houben-Weyl), Vol. 14/1, Georg Thieme-Verlag, Stuttgart 1961, p. 393-406 and in C. B. Bucknall, “Toughened Plastics”, Appl. Science Publishers, London 1977. Preferred polymers B* are partially crosslinked and have gel contents (measured in toluene) of over 20 wt. %, preferably over 40 wt. %, in particular over 60 wt. %.

The gel content is determined at 25° C. in a suitable solvent (M. Hoffmann, H. Krömer, R. Kuhn, Polymeranalytik I und II, Georg Thieme-Verlag, Stuttgart 1977).

Preferred graft polymers B* comprise graft polymers of:
B*.1) from 5 to 95 parts by weight, preferably from 30 to 80 parts by weight, of a mixture of
B*.1.1) from 50 to 95 parts by weight of styrene, α-methylstyrene, styrene methyl-substituted on the ring, C₁-C₈-alkyl methacrylate, in particular methyl methacrylate, C₁-C₈-alkyl acrylate, in particular methyl acrylate, or mixtures of these compounds, and
B*.1.2) from 5 to 50 parts by weight of acrylonitrile, methacrylonitrile, C₁-C₈-alkyl methacrylates, in particular methyl methacrylate, C₁-C₈-alkyl acrylate, in particular methyl acrylate, maleic anhydride, C₁-C₄-alkyl- or -phenyl-N-substituted maleimides, or mixtures of these compounds, on
B*.2) from 5 to 95 parts by weight, preferably from 20 to 70 parts by weight, of a rubber-containing graft base.

The graft base preferably has a glass transition temperature below −10° C.

A graft base based on a polybutadiene rubber is particularly preferred.

The glass transition temperature is determined by means of differential scanning calorimetry (DSC) according to standard DIN EN 61006 at a heating rate of 10 K/min with definition of the T_{g} as the mid-point temperature (tangent method).

Preferred graft polymers B* are, for example, polybutadienes, butadiene/styrene copolymers and acrylate rubbers gafted with styrene and/or acrylonitrile and/or (meth)acrylic acid alkyl esters; that is to say copolymers of the type described in DE-OS 1 694 173 (=US-PS 3 564 077); polybutadienes, butadiene/styrene or butadiene/acrylonitrile copolymers grafted with acrylic or methacrylic acid alkyl esters, vinyl acetate, acrylonitrile, styrene and/or alkylstyrenes, as are described, for example, in DE-OS 2 348 377 (=US-PS 3 919 353).

Particularly preferred graft polymers B* are graft polymers obtainable by graft reaction of
I. from 10 to 70 wt. %, preferably from 15 to 50 wt. %, in particular from 20 to 40 wt. %, based on graft product, of at least one (meth)acrylic acid ester or from 10 to 70 wt. %, preferably from 15 to 50 wt. %, in particular from 20 to 40 wt. %, of a mixture of from 10 to 50 wt. %, preferably from 20 to 35 wt. %, based on the mixture, of acrylonitrile or (meth)acrylic acid ester and from 50 to 90 wt. %, preferably from 65 to 80 wt. %, based on the mixture, of styrene, on
II. from 30 to 90 wt. %, preferably from 40 to 85 wt. %, in particular from 50 to 80 wt. %, based on graft product, of a butadiene polymer having at least 50 wt. %, based on II, of butadiene radicals as graft base.

The gel content of this graft base II is preferably at least 70 wt. % (measured in toluene), the degree of grafting G is from 0.15 to 0.55, and the mean particle diameter d₅₀ of the graft polymer B* is from 0.05 to 2 μm, preferably from 0.1 to 0.6 μm.

(Meth)acrylic acid esters I are esters of acrylic acid or methacrylic acid and monohydric alcohols having from 1 to 18 carbon atoms. Methacrylic acid methyl esters, ethyl esters and propyl esters are particularly preferred.

In addition to butadiene radicals, the graft base II can comprise up to 50 wt. %, based on II, of radicals of other ethylenically unsaturated monomers, such as styrene, acrylonitrile, esters of acrylic or methacrylic acid having from 1 to 4 carbon atoms in the alcohol component (such as methyl acrylate, ethyl acrylate, methyl methacrylate, ethyl methacrylate), vinyl esters and/or vinyl ethers. The preferred graft base II consists of pure polybutadiene.

Because, as is known, the graft monomers are not necessarily grafted completely onto the graft base in the graft reaction, graft polymers B* are also understood as being products that are obtained by polymerisation of the graft monomers in the presence of the graft base.

The moulding compositions preferably have a total content of polymer formed from the graft monomers or added freely and not chemically bonded to the graft base, for example free SAN, of less than 2.0 wt. %, preferably less than 1.5 wt. % (that is to say from 0.0 to 2.0 wt. %, preferably from 0.0 to 1.5 wt. %), based on the total moulding composition. If this amount is increased, the properties are drastically impaired.

The degree of grafting G refers to the weight ratio of grafted graft monomers to the graft base and is dimensionless.

The mean particle size d₅₀ is the diameter above and below which in each case 50 wt. % of the particles lie. It can be determined by means of ultracentrifuge measurements (W. Scholtan, H. Lange, Kolloid, Z. und Z. Polymere 250 (1972), 782-796).

Further preferred graft polymers B* are, for example, also graft polymers of
(a) from 20 to 90 wt. %, based on B*, of acrylate rubber as graft base and
(b) from 10 to 80 wt. %, based on B*, of at least one polymerisable, ethylenically unsaturated monomer, the homo- or co-polymers of which formed in the absence of a) would have a glass transition temperature over 25° C., as graft monomer.

The graft base of acrylate rubber has a glass transition temperature of less than −20° C., preferably less than −30° C.

The acrylate rubbers (a) of the polymers B* are preferably polymers of acrylic acid alkyl esters, optionally with up to 40 wt. %, based on (a), of other polymerisable, ethylenically unsaturated monomers. The preferred polymerisable acrylic acid esters include C₁-C₅-alkyl esters, for example methyl, ethyl, n-butyl, n-octyl and 2-ethylhexyl esters, and mixtures of these monomers.

For crosslinking, monomers having more than one polymerisable double bond can be copolymerised. Preferred examples of crosslinking monomers are esters of unsaturated monocarboxylic acids having from 3 to 8 carbon atoms and unsaturated monohydric alcohols having from 3 to 12 carbon atoms or saturated polyols having from 2 to 4 OH groups and from 2 to 20 carbon atoms, such as, for example, ethylene glycol dimethacrylate, allyl methacrylate; polyunsaturated heterocyclic compounds, such as, for example, trivinyl and triallyl cyanurate; polyfunctional vinyl compounds, such as di- and tri-vinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, trivinyl cyanurate, triacryloylhexahydro-s-triazine, triallylbenzenes.

The amount of crosslinking monomers is preferably from 0.02 to 500 wt. %, in particular from 0.05 to 2.00 wt. %, based on graft base (a).

In the case of cyclic crosslinking monomers having at least 3 ethylenically unsaturated groups, it is advantageous to limit the amount to less than 1 wt. % of the graft base (a).

Preferred “other” polymerisable, ethylenically unsaturated monomers which can optionally be used together with the acrylic acid esters for the preparation of the graft base (a) are, for example, acrylonitrile, styrene, α-methylstyrene, acrylamides, vinyl C₁-C₆-alkyl ethers, methyl methacrylate, butadiene. Preferred acrylate rubbers as graft base (a) are emulsion polymers having a gel content of at least 60 wt. %.

### Component C

The compositions further comprise flame retardants, the flame retardants preferably being selected from the group comprising phosphorus-containing flame retardants and halogenated flame retardants.

Particular preference is given to phosphorus-containing flame retardants, these phosphorus-containing flame retardants being selected from the groups of the monomeric and oligomeric phosphoric and phosphonic acid esters, phosphonate amines, phosphazenes and phosphinic acid salts, it also being possible to use as flame retardants mixtures of a plurality of components selected from one or various of these groups. Other halogen-free phosphorus compounds not mentioned specifically here can also be used, on their own or in arbitrary combination with other halogen-free phosphorus compounds.

Preferred monomeric and oligomeric phosphoric and phosphonic acid esters are phosphorus compounds of the general formula (VI)

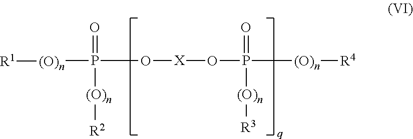

wherein
R1, R2, R3 and R4 independently of one another each denote optionally halogenated C1- to C8-alkyl; C5- to C6-cycloalkyl, C6- to C20-aryl or C7- to C12-aralkyl each optionally substituted by alkyl, preferably C1- to C4-alkyl, and/or by halogen, preferably chlorine, bromine,
n independently of one another denote 0 or 1,
q denotes from 0 to 30 and
X denotes a mono- or poly-nuclear aromatic radical having from 6 to 30 carbon atoms, or a linear or branched aliphatic radical having from 2 to 30 carbon atoms which can be OH-substituted and can contain up to eight ether bonds.

Preferably, R1, R2, R3 and R4 independently of one another represent C1- to C4-alkyl, phenyl, naphthyl or phenyl-C1-C4-alkyl. The aromatic groups R1, R2, R3 and R4 can in turn be substituted by halogen and/or alkyl groups, preferably chlorine, bromine and/or C1- to C4-alkyl. Particularly preferred aryl radicals are cresyl, phenyl, xylenyl, propylphenyl or butylphenyl and also the corresponding brominated and chlorinated derivatives thereof.

X in formula (VI) preferably denotes a mono- or poly-nuclear aromatic radical having from 6 to 30 carbon atoms. This radical is preferably derived from diphenols of formula (I).
n in formula (VI) can, independently of one another, be 0 or 1, n is preferably equal to 1.
q (also in formula VII) represents whole-number values of from 0 to 30, preferably from 0 to 20, particularly preferably from 0 to 10, in the case of mixtures represents average values of from 0.8 to 5.0, preferably from 1.0 to 3.0, more preferably from 1.05 to 2.00 and particularly preferably from 1.08 to 1.60.
X particularly preferably represents

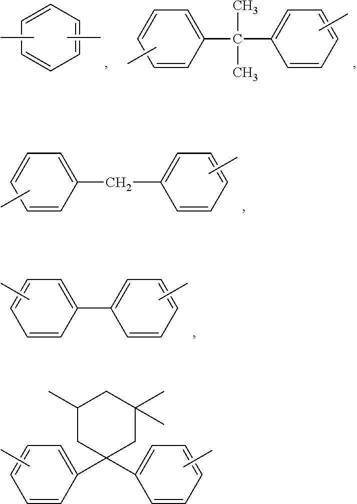

or chlorinated or brominated derivatives thereof, in particular X is derived from resorcinol, hydroquinone, bisphenol A or diphenylphenol. X is particularly preferably derived from bisphenol A.

Phosphorus compounds of formula (VI) are in particular tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, resorcinol-bridged oligophosphate and bisphenol A-bridged oligophosphate. The use of oligomeric phosphoric acid esters of formula (VI) which are derived from bisphenol A is particularly preferred.

Most preferred as component C is bisphenol A-based oligophosphate according to formula (VIa)

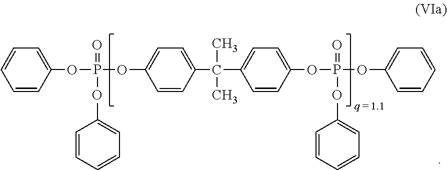

In an alternative preferred embodiment, component C is resorcinol-based oligophosphate according to formula (VIb)

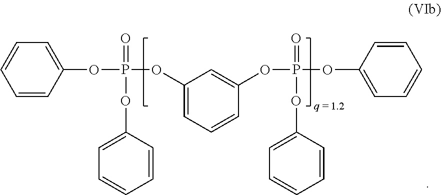

The phosphorus compounds according to component C are known (see e.g. EP-A 0 363 608, EP-A 0 640 655) or can be prepared by known methods in an analogous manner (e.g. Ullmanns Enzyklopädie der technischen Chemie, Vol. 18, p. 301 if. 1979; Houben-Weyl, Methoden der organischen Chemie, Vol. 12/1, p. 43; Beilstein Vol. 6, p. 177).

There can also be used as component C mixtures of phosphates having different chemical structures and/or having the same chemical structure and different molecular weights.

Mixtures having the same structure and a different chain length are preferably used, the indicated q value being the mean q value. The mean q value can be determined by determining the composition of the phosphorus compound (molecular weight distribution) by means of a suitable method (gas chromatography (GC), high pressure liquid chromatography (HPLC), gel permeation chromatography (GPC)) and calculating the mean values for q therefrom.

Phosphonate amines and phosphazenes, as are described in WO 00/00541 and WO 01/18105, can further be used as flame retardants.

The flame retardants can be used on their own or in an arbitrary mixture with one another or in a mixture with other flame retardants.

Further preferred flame retardants are salts of a phosphinic acid with any desired metal cations. It is also possible to use mixtures of salts which differ in their metal cation. The metal cations are the cations metals of main group 1 (alkali metals, preferably Li⁺, Na⁺, K⁺), of main group 2 (alkaline earth metals; preferably Mg²⁺, Ca²⁺, Sr²⁺, Ba²⁺, particularly preferably Ca²⁺) or of main group 3 (elements of the boron group; preferably Al³⁺) and/or of subgroup 2, 7 or 8 (preferably Zn²⁺, Mn²⁺, Fe²⁺, Fe³⁺) of the periodic system.

Preference is given to the use of a salt or a mixture of salts of a phosphinic acid of formula (IX)

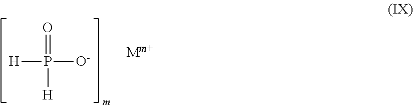

wherein M^{m+} is a metal cation of main group 1 (alkali metals; m=1), of main group 2 (alkaline earth metals; m=2) or of main group 3 (m=3) or of subgroup 2, 7 or 8 (wherein m denotes an integer from 1 to 6, preferably from 1 to 3 and particularly preferably 2 or 3) of the periodic system.

Particular preference is given in formula (IX)

for m=1 to the metal cations M⁺=Li⁺, Na⁺, K⁺,
for m=2 to the metal cations M²⁺=Mg²⁺, Ca²⁺, Sr²⁺, Ba²⁺ and
for m=3 to the metal cations M³⁺=Al³′,
Ca²⁺ (m=2) and Al³⁺ (m=3) being most particularly preferred.

In a preferred embodiment, the mean particle size d₅₀ of the phosphinic acid salt (component C) is less than 80 μm, preferably less than 60 μm, d₅₀ is particularly preferably between 10 μm and 55 μm. The mean particle size d₅₀ is the diameter above and below which in each case 50 wt. % of the particles lie. It is also possible to use mixtures of salts which differ in their mean particle size d₅₀.

These requirements as regards the particle size are in each case associated with the technical effect that the flame-retarding efficiency of the phosphinic acid salt is increased.

The phosphinic acid salt can be used either on its own or in combination with other phosphorus-containing flame retardants.

### Component D

The compositions can comprise as antidripping agents preferably fluorinated polyolefins D. Fluorinated polyolefins are generally known (see e.g. EP-A 640 655). A commercially available product is, for example, Teflon* 30 N from DuPont.

The fluorinated polyolefins can also be used in the form of a coagulated mixture of emulsions of the fluorinated polyolefins with emulsions of the graft polymers B) or B*) or an emulsion of a copolymer E.1) preferably based on styrene/acrylonitrile or on polymethyl methacrylate, the fluorinated polyolefin being mixed in the form of an emulsion with an emulsion of the graft polymer or (co)polymer and subsequently being coagulated.

The fluorinated polyolefins can further be used in the form of a precompound with the graft polymer B) or a copolymer E.I) preferably based on styrene/acrylonitrile or on polymethyl methacrylate. The fluorinated polyolefins are mixed in the form of a powder with a powder or granulate of the graft polymer or copolymer and compounded in the melt generally at temperatures of from 200 to 330° C. in conventional devices such as internal kneaders, extruders or twin-shaft screws.

The fluorinated polyolefins can also be used in the form of a masterbatch, which is prepared by emulsion polymerisation of at least one monoethylenically unsaturated monomer in the presence of an aqueous dispersion of the fluorinated polyolefin. Preferred monomer components are styrene, acrylonitrile, polymethyl methacrylate and mixtures thereof. The polymer is used as a pourable powder after acid precipitation and subsequent drying.

The coagulates, precompounds and masterbatches usually have solids contents of fluorinated polyolefin of from 5 to 95 wt. %, preferably from 7 to 60 wt. %.

### Component E

Component E comprises one or more thermoplastic vinyl (co)polymers E.1 and/or polyalkylene terephthalates E.2.

Suitable vinyl (co)polymers E.1 are polymers of at least one monomer from the group of the vinyl aromatic compounds, vinyl cyanides (unsaturated nitriles), unsaturated carboxylic acids and derivatives (such as esters, anhydrides and imides) of unsaturated carboxylic acids. Particularly suitable are (co)polymers of
E.1.1 from 50 to 99 parts by weight, preferably from 60 to 80 parts by weight, of vinyl aromatic compounds and/or vinyl aromatic compounds substituted on the ring (such as styrene, α-methylstyrene, p-methylstyrene, p-chlorostyrene), and
E.1.2 from 1 to 50 parts by weight, preferably from 20 to 40 parts by weight, of vinyl cyanides (unsaturated nitriles, such as acrylonitrile and methacrylonitrile) and/or unsaturated carboxylic acids (such as acrylic acid and maleic acid) and/or derivatives (such as anhydrides and imides) of unsaturated carboxylic acids (for example maleic anhydride and N-phenylmaleimide).

The vinyl (co)polymers E.1 are resin-like, thermoplastic and rubber-free. Particular preference is given to the copolymer of E. 1.1 styrene and E. 1.2 acrylonitrile.

The (co)polymers according to E.1 are known and can be prepared by radical polymerisation, in particular by emulsion, suspension, solution or mass polymerisation. The (co)polymers preferably have mean molecular weights Mw (weight average, determined by light scattering or sedimentation) of from 15,000 to 200,000.

The polyalkylene terephthalates of component E.2 are reaction products of aromatic dicarboxylic acids or reactive derivatives thereof, such as dimethyl esters or anhydrides, and aliphatic, cycloaliphatic or araliphatic diols, and mixtures of these reaction products. Preferred polyalkylene terephthalates comprise at least 80 wt. %, preferably at least 90 wt. %, based on the dicarboxylic acid component, of terephthalic acid radicals and at least 80 wt. %, preferably at least 90 mol %, based on the diol component, of ethylene glycol and/or 1,4-butanediol radicals.

The preferred polyalkylene terephthalates can comprise, in addition to terephthalic acid radicals, up to 20 mol %, preferably up to 10 mol %, of radicals of other aromatic or cycloaliphatic dicarboxylic acids having from 8 to 14 carbon atoms or aliphatic dicarboxylic acids having from 4 to 12 carbon atoms, such as, for example, radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates can comprise, in addition to ethylene glycol and 1,4-butanediol radicals, up to 20 mol %, preferably up to 10 mol %, of other aliphatic diols having from 3 to 12 carbon atoms or cycloaliphatic diols having from 6 to 21 carbon atoms, for example radicals of 1,3-propanediol, 2-ethyl-1,3-propanediol, neopentyl glycol, 1,5-pentanediol, 1,6-hexanediol, 1,4-cyclohexanedimethanol, 3-ethyl-2,4-pentanediol, 2-methyl-2,4-pentanediol, 2,2,4-trimethyl- 1,3-pentanediol, 2-ethyl-1,3-hexanediol, 2,2-diethyl-1,3-propenediol, 2,5-hexanediol, 1,4-di-((3-hydroxyethoxy)-benzene, 2,2-bis-(4-hydroxycyclohexyl)-propane, 2,4-dihydroxy-1,1,3,3-tetramethyl-cyclobutane, 2,2-bis-(4-B-hydroxyethoxy-phenyl)-propane and 2,2-bis-(4-hydroxy-propoxyphenyl)-propane (DE-A 2 407 674, 2 407 776, 2 715 932).

The polyalkylene terephthalates can be branched by incorporating relatively small amounts of 3- or 4-hydric alcohols or 3- or 4-basic carboxylic acids, for example according to DE-A 1 900 270 and US-PS 3 692 744. Examples of preferred branching agents are trimesic acid, trimellitic acid, trimethylol-ethane and -propane and pentaerythritol.

Particular preference is given to polyalkylene terephthalates that have been prepared solely from terephthalic acid and reactive derivatives thereof (e.g. dialkyl esters thereof) and ethylene glycol and/or 1,4-butanediol, and mixtures of such polyalkylene terephthalates.

Mixtures of polyalkylene terephthalates comprise from 1 to 50 wt. %, preferably from 1 to 30 wt. %, polyethylene terephthalate and from 50 to 99 wt. %, preferably from 70 to 99 wt. %, polybutylene terephthalate.

The polyalkylene terephthalates that are preferably used generally have an intrinsic viscosity of from 0.4 to 1.5 dl/g, preferably from 0.5 to 1.2 dl/g, measured in phenol/o-dichlorobenzene (1:1 parts by weight) at 25° C. in an Ubbelohde viscometer.

The polyalkylene terephthalates can be prepared by known methods (see e.g. Kunststoff-Handbuch, Volume VIII, p. 695 if, Carl-Hanser-Verlag, Munich 1973).

### Further Additives F

The moulding compositions can comprise at least one of the conventional additives, such as, for example, lubricants and demoulding agents, nucleating agents, antistatics, stabilisers, colourings and pigments, and fillers and reinforcing agents.

Component F also includes very finely divided inorganic compounds, which are distinguished by an average particle diameter of less than or equal to 200 nm, preferably less than or equal to 150 nm, in particular from 1 to 100 nm. Suitable very finely divided inorganic compounds preferably consist of at least one polar compound of one or more metals of main group 1 to 5 or subgroup 1 to 8 of the periodic system, preferably of main group 2 to 5 or subgroup 4 to 8, particularly preferably of main group 3 to 5 or subgroup 4 to 8, or compounds of those metals with at least one element selected from oxygen, hydrogen, sulfur, phosphorus, boron, carbon, nitrogen or silicon. Preferred compounds are, for example, oxides, hydroxides, water-containing oxides, sulfates, sulfites, sulfides, carbonates, carbides, nitrates, nitrites, nitrides, borates, silicates, phosphates, hydrides, phosphites or phosphonates. The very finely divided inorganic compounds preferably consist of oxides, phosphates, hydroxides, preferably of TiO₂, SiO₂, SnO₂, ZnO, ZnS, boehmite, ZrO₂, AL₂O₃, aluminium phosphates, iron oxides, also TiN, WC, AlO(OH), Fe₂O₃iron oxides, NaSO₄, vanadium oxides, zinc borate, silicates such as Al silicates, Mg silicates, one-, two- and three-dimensional silicates and talc. Mixtures and doped compounds can likewise be used.

These very finely divided inorganic compounds can further be surface-modified with organic molecules in order to achieve better compatibility with the polymers. In this manner, hydrophobic or hydrophilic surfaces can be produced. Particular preference is given to hydrate-containing aluminium oxides (e.g. boehmite) or TiO₂.

Particle size and particle diameter of the inorganic particles denotes the mean particle diameter d₅₀, determined, for example, by sedimentation measurements via the settling speed of the particles, for example in a sedigraph.

The inorganic compounds can be in the form of powders, pastes, sols, dispersions or suspensions. Powders can be obtained from dispersions, sols or suspensions by precipitation.

The inorganic compounds can be incorporated into the thermoplastic moulding compositions by conventional processes, for example by direct kneading or extrusion of moulding compositions and the very finely divided inorganic compounds. Preferred processes are the preparation of a masterbatch, for example in flame retardant additives and at least one component of the moulding compositions in monomers or solvents, or the coprecipitation of a thermoplastic component and the very finely divided inorganic compounds, for example by coprecipitation of an aqueous emulsion and the very finely divided inorganic compounds, optionally in the form of dispersions, suspensions, pastes or sols of the very finely divided inorganic materials.

The compositions are prepared by mixing the constituents in question in known manner and melt-compounding and melt-extruding the mixture at temperatures of from 200° C. to 300° C. in conventional devices such as internal kneaders, extruders and twin-shaft screws. Mixing of the individual constituents can take place in known manner both in succession and simultaneously, both at approximately 20° C. (room temperature) and at elevated temperature.

On account of their excellent balance of high impact strength at low temperatures, good flame resistance at thin wall thicknesses and excellent resistance to chemicals, the thermoplastic compositions and moulding compositions are suitable for the production of battery module housings or battery pack housings or parts thereof.

In one embodiment, component C is selected from phosphorus compounds according to formula (VII)

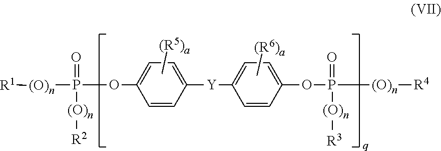

wherein
R¹, R², R³ and R⁴ independently of one another denote C₁-C₈-alkyl optionally substituted by halogen; C₅-C₆-cycloalkyl, C₆-C₁₀-aryl or C₇-C₁₂-aralkyl each optionally substituted by halogen and/or by alkyl,
n independently of one another denotes 0 or 1,
a independently of one another denotes 0, 1, 2, 3 or 4,
q denotes from 0 to 30,
R5 and R6 independently of one another denote C₁-C₄-alkyl, preferably methyl, or halogen, preferably chlorine and/or bromine, and
Y denotes C₁-C₇-alkylidene, C₁-C₇-alkylene, C₅-C₁₂-cycloalkylene, C₅-C₁₂-cycloalkylidene, —O—, —S—, —SO—, —SO₂— or —CO—.

In a further embodiment, in which the polycarbonate composition comprises components A+B+C and optionally components D, E and/or F, the amount of component B is from 9.0 to 11.0 parts by weight (based on the sum of components A+B+C).

In a further embodiment, in which the polycarbonate composition comprises components A+B*+C and optionally components D, E and/or F, the amount of component B* is from 9.0 to 11.0 parts by weight (based on the sum of components A+B*+C).

In a further embodiment, the amount of component C is from 4.0 to 11.0 parts by weight (based on the sum of components A+B+C or A+B*+C).

In a further embodiment, the polycarbonate composition comprises as component C a mixture of a monophosphate and an oligophosphate according to formula (VII), wherein the average value of q is from 1.06 to 1.15.

In a further embodiment, the amount of component D is from 0.1 to 0.6 part by weight (based on the sum of components A+B+C or A+B*+C).

In a further embodiment, the polycarbonate composition comprises as component F at least one additive selected from the group consisting of lubricants and demoulding agents, nucleating agents, antistatics, stabilisers, colourings, pigments, fillers, reinforcing agents and very finely divided inorganic compounds, wherein the very finely divided inorganic compounds have an average particle diameter of less than or equal to 200 nm.

In addition to or instead of polycarbonate materials, the battery module housings can also comprise other suitable plastics, in particular thermosetting or thermoplastic plastics, such as, for example, polypropylenes (PP), polyamides (PA), polybutylene terephthalates (PBT), acrylonitrile-butadiene-styrene (ABS), PA/ABS mixtures, PC/ABS mixtures, PC-ASA (acrylic ester-styrene-acrylonitrile) mixtures, or further mixtures thereof. Furthermore, flame-retardant thermoplastics, for example the plastics mentioned above with the addition of flame retardants, are particularly suitable for the battery module housings.

In a further embodiment of the battery module, the battery module comprises the specified number of battery cells, wherein the individual battery cells are received in the receivers. In the case of N receivers, the battery module accordingly comprises N battery cells, wherein a battery cell is arranged in each receiver for a battery cell. The battery cells can in particular be lithium ion cells, for example of type 18650 or alternatively of type 10180, 10280, 10440, 14250, 14500, 14560, 15270, 16340, 17340, 17500, 17670, 18350, 18500, 19670, 25500, 26650 or 32600.

When a resilient element is arranged in the escape area of the battery module, the resilient element is preferably adapted to at least one adjacent battery cell in such a manner that it is compressed by not more than 10% of its original extent in the case of an acceleration of the adjacent battery cell of up to 10 g, where g in the present case is the acceleration due to gravity of the earth (g≈9.81 m/s²). To that end, the resilient element can in particular be so configured that a restoring force of at least 10·g·M_{BC} is obtained in the case of compression by not more than 10%0, where Mac is the weight of a battery cell. More preferably, the resilient element is adapted to at least one battery cell in such a manner that it is compressed by at least 50% of its original extent in the case of an acceleration of the adjacent battery cell of at least 12 g, in particular of at least 15 g.

If the battery module has a collar element or holding element on a receiver, those elements are preferably in such a form that they free the battery cell in the case of an acceleration of the battery cell in the receiver of more than 12 g, in particular more than 15 g, for example by tipping over, breaking off of the collar element or holding element, or in another manner.

According to the invention, the above-mentioned object is further achieved at least partially in the case of a battery pack having a battery pack housing, wherein the battery pack housing encloses a battery pack compartment and wherein the battery pack housing has on the battery pack compartment side at least one receiver for a battery module, in that the battery pack has a battery module according to the invention received in the receiver.

Electric vehicles are frequently fitted not with individual battery modules but with battery packs, in which a plurality of battery modules are combined in a battery pack housing. By providing such a battery pack with battery modules according to the invention, the advantages described hereinbefore for the battery module according to the invention are also achieved in the case of the battery pack.

For receiving the battery modules, the battery pack can have, for example, supports, tracks, depressions or other holding means on the battery pack compartment side, that is to say on the inside of the battery pack housing.

In one embodiment of the battery pack, the battery pack housing is at least partially resilient. Preferably, at least one side wall or a plurality of side walls or substantially the entire battery pack housing is resilient. In this manner, the battery pack housing is resiliently deformed at least partially under the action of a great force as in the event of a crash, so that space for the resilient deformation of a battery module arranged in the battery pack housing is provided. With regard to the advantages of a resilient deformation of the battery module, reference is made to the above description of the battery module.

In order to enable the battery module to be deformed resiliently, the resilient part of the battery pack housing preferably has a modulus of elasticity of not more than 80,000 N/mm², in particular of not more than 30,000 N/mm². On the other hand, the resilient part preferably has a modulus of elasticity of at least 750 N/mm², preferably of at least 1000 N/mm², in particular of at least 2000 N/mm², in order to ensure that the battery modules are housed securely and firmly in normal operation, that is to say without the action of a great external force as in the event of a crash.

In a further embodiment of the battery pack, the battery pack housing has at least partially a normalised rigidity of less than 140,000 Nmm², preferably less than 50,000 Nmm², in particular less than 25,000 Nmm². In this manner, comparable advantages can be achieved as for an at least partially resilient battery pack housing. Preferably, at least one side wall or a plurality of side walls or substantially the entire battery pack housing has the indicated flexural rigidity.

There is preferably used for the battery pack housing a material having an elongation at break according to DIN ISO 527-1,-2 of at least 2%, preferably of at least 15%, in particular of at least 30%.

In a further embodiment of the battery pack, the battery pack has an escape area in the battery pack compartment on at least one side of the battery module, so that the battery module is spaced apart from the battery pack housing and other battery modules in the battery pack on that side. Such an escape area ensures that, under the action of a great force, as in the event of a crash, sufficient deformation of the battery module within the battery pack is possible. Thus, for example, the cover, the base or a side wall of the battery module housing can be curved into the escape area of the battery pack so that, within the battery module itself, an escape area for the battery cells can be created, or the battery cells are displaceable inside the battery module in order to escape the force acting upon them.

The size of the escape area, that is to say the distance of the battery module from the battery pack housing or other battery modules, is preferably at least 30 mm, or at least 20% of the size of the battery module in the direction of the side on which the escape area is arranged.

A resilient element such as, for example, a foam or a spring element can be arranged in the escape area of the battery pack in order to fix the battery modules securely inside the battery pack in normal operation.

In a further embodiment of the battery pack, the battery pack housing comprises a polycarbonate material. As stated above in relation to the battery module housing, polycarbonate materials have good resilience and high strength, in particular also at low temperatures of −30° C., which can occur when used in electric vehicles. Furthermore, good flame retardancy of those materials is possible.

Suitable polycarbonate materials for the battery pack housing are in principle the polycarbonate compositions already listed above for the battery module housing, so that reference is made to the description of those compositions.

The other materials mentioned above for the battery module housing, in particular the flame-retardant thermoplastics, are also suitable for the battery pack housing. The above-mentioned fibre-reinforced composite materials, as described for the battery module, can also be used.

The battery pack housing can further also comprise a metal material, in particular an aluminium or steel alloy. In combination with battery module housings of plastic, it is thus possible to achieve a hybrid structure in which the battery modules are protected by a rigid battery pack housing and the battery cells are able to escape the transmitted forces if that protection fails.

According to the invention, the above-mentioned object is further achieved at least partially in the case of an electric vehicle in that the electric vehicle has a battery module according to the invention and/or a battery pack according to the invention.

By providing such a battery module or battery pack in an electric vehicle, it is possible, owing to the increased operating safety of the battery module or battery pack, correspondingly also to improve the operating safety of the electric vehicle. With regard to the other advantages, reference is made to the above description relating to the battery module and the battery pack.

Further features and advantages of the invention can be found in the following description of exemplary embodiments, in which reference is made to the accompanying drawing, in which:

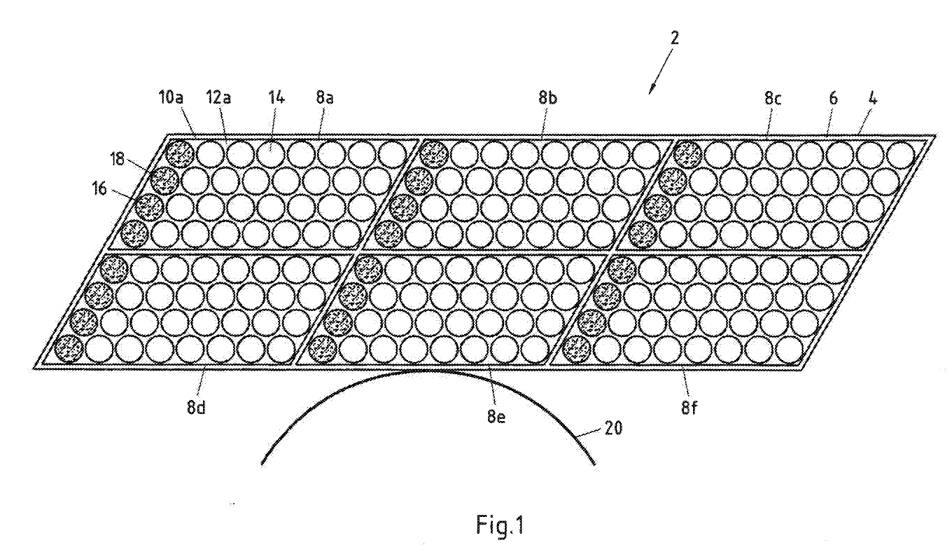

FIG. 1 shows an exemplary embodiment of a battery module according to the invention and of a battery pack according to the invention,

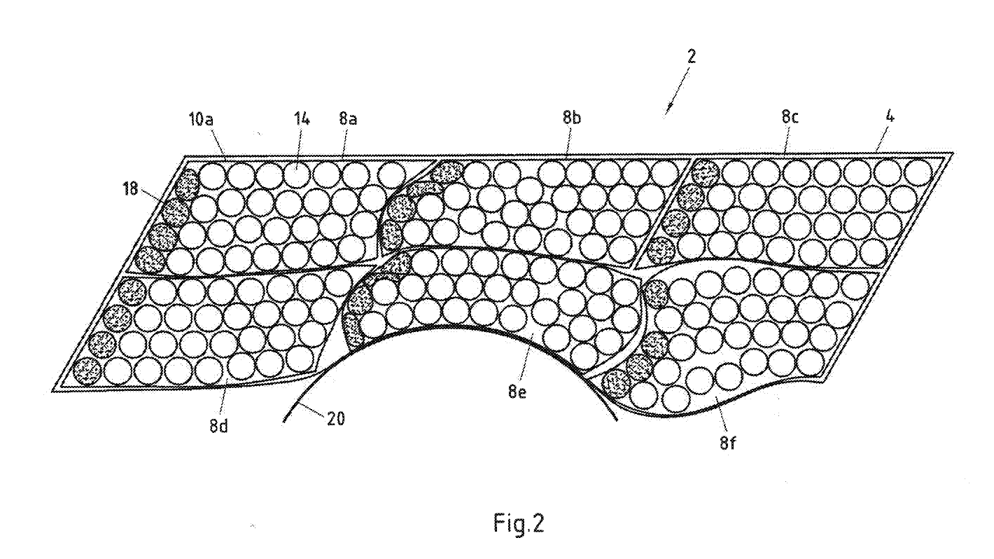

FIG. 2 shows the exemplary embodiment of FIG. 1 after the action of a strong force as in the event of a crash,

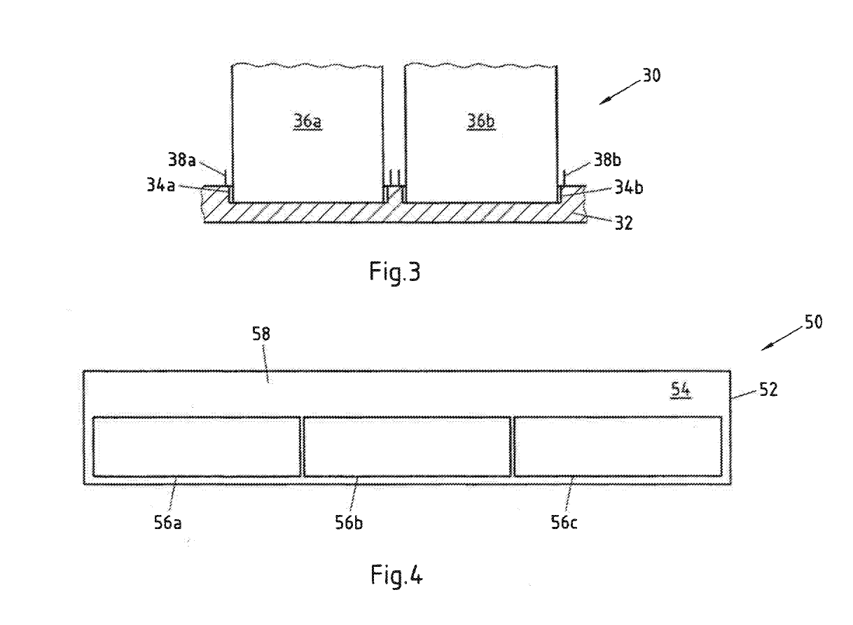

FIG. 3 shows a detail view of an exemplary embodiment of a battery module according to the invention, and

FIG. 4 shows an exemplary embodiment of a battery pack according to the invention.

FIG. 1 shows a top view in horizontal section of an exemplary embodiment of a battery module according to the invention and of a battery pack according to the invention.

The battery pack 2 has a battery pack housing 4, which is based on a polycarbonate material and has a modulus of elasticity of less than 50,000 N/mm² and in the present case is substantially wholly resilient. The battery pack housing 4 encloses a battery pack compartment 6, in which six battery modules 8a-f are arranged in six receivers (not shown) provided therefor. The battery modules 8a-f are of identical construction in the present exemplary embodiment, but they can also differ in terms of their construction. The structure of the battery modules 8a-f is described by way of example below with reference to the battery module 8a.

Battery module 8a has a battery module housing 10a, which is based on a polycarbonate material and has a modulus of elasticity of less than 50,000 N/mm² and in the present case is likewise substantially wholly resilient. The battery module housing 10a encloses a battery module compartment 12a, in which 28 battery cells 14 are arranged in 28 receivers (not shown) provided therefor. The battery cells 14 are arranged offset in rows, in order to achieve as high a packing density as possible. The battery module 8a further has in the battery module compartment 12a an escape area 16, in which four resilient elements 18 are arranged. The resilient elements 18 are each in the form of a foam cylinder in the present exemplary embodiment. However, other forms and types of resilient elements are also conceivable. The resilient elements 18 are also arranged in the edge area of the battery module compartment 12a in the exemplary embodiment shown. Alternatively, the resilient elements 18 can, however, also be arranged in other places in the battery module compartment 12a, for example centrally in the battery module and surrounded by battery cells 14.

The behaviour of the exemplary embodiment of a battery pack 2 having the battery modules 8a-f shown in FIG. 1 when subjected to a great external force, as in the event of a crash, has been studied by means of a computer simulation. FIG. 1 shows the situation of the battery pack 2 before a crash. The line drawn in FIG. 1 represents a force front 20 which could act locally on the battery pack 2 in the event of a crash.

The computer simulation of the battery pack shown in FIG. 1 was carried out by CAE methods (Computer Aided Engineering). To that end, the software Simulia Abaqus 6.12-2 from Dassault Systeme was used.

The simulation was carried out on the basis of the pole side impact as described by Euro NCAP or in FMVSS 201. Because the simulation took into consideration only the battery pack 2 with the battery modules 8a-f and did not take account of the rigidity of other vehicle components as in a total vehicle model, the pole-shaped impactor (with a diameter of d=254 mm) in the pole side impact was driven into the battery pack 2 as a massless rigid body with a constant rate of travel. The rate of travel was v=29 km/h. The force front shown in FIG. 1 corresponds in this simulation to the edge of the pole-shaped impactor in the moment before the impact.

Because the exact rigidities of a battery cell 14 were not known, each cell was formed by shell elements of steel having a diameter of d=40 mm and a wall thickness of t=5 mm. This rigidity ensures that the individual battery cells are not deformed during the simulation and each retain an ideal cylindrical cross-section. In order that the battery cells 14, the pole-shaped impactor and the battery pack housing 4 and the battery module housings 10a-f are able to interact in the simulation, contacts were defined between the pole-shaped impactor and the battery pack housing 4, the battery cells 14 with one another, the battery cells 14 with the respective battery module housing 10a-f, the battery cells 14 with the resilient elements 18, and between the battery module housings 10a-f with one another and with the battery pack housing 4.

In order that the contact of the battery cells 14 of steel in the simulation did not lead to inadmissibly high vibrations, a resilient damping element having a modulus of elasticity of 20 N/mm² and a thickness of 1 mm was placed around the battery cells 14. Each horizontal row of battery cells 14 had on the left side a resilient element 18 of thermoplastic plastic with a modulus of elasticity of E=2200 MPa. The geometrical form of the resilient elements 18 was such that they corresponded in height and diameter to the dimensions of a battery cell 14. The wall thickness of the resilient elements 18 was t=1.5 mm. The battery module housings 10a-f and the battery pack housing 4 consisted of the same thermoplastic plastic as the resilient elements 18 but had a thickness of t=5 mm.

FIG. 2 shows the battery pack 2 of FIG. 1 after being subjected to a strong force as in the event of a crash. The deformation of the battery pack 2 and its constituents as a result of the action of force was calculated by means of the above-described computer simulation, in which the action of a great force on the battery pack 2 was simulated by the force front 20 penetrating the battery pack 2. As a result of the simulated action of force at the force front 20, both the battery pack housing 4 and the battery module housings such as 10a exhibit considerable deformation. As can be seen in FIG. 2, the resilient battery pack housing 4 and the resilient battery module housings were deformed in particular not only locally in the area of the force front 20 but also in areas remote from the force front 20. Furthermore, the resilient elements 18 inside the battery modules 8a-f were in some cases compressed and deformed considerably, so that escape areas were created into which the battery cells 14 could be displaced. Accordingly, FIG. 2 shows that the individual battery cells 14 have in some cases been displaced far from their original positions and were thus able to escape the action of force by the force front 20. It has been shown that the forces acting on the individual battery cells could be reduced considerably compared with the force front acting from outside, so that the risk of damage to the battery cells has fallen significantly.

FIG. 3 shows a detail of a battery module 30 with a battery module housing 32, of which a base portion is shown in FIG. 3. In the base of the battery module housing 32 there are provided depressions 34a-b, the dimensions of which are adapted to the battery cells 36a-b that are to be arranged in the battery module housing. The battery cells 36a-b are thus fixed in the receivers 34a-b in normal operation. There are additionally provided on the base portion of the battery module housing 32 collar elements 38a-b, which ensure additional fixing of the battery cells 36a-b in normal operation. Under the action of a great force, the collar elements 38a-b are able to fold down and thus allow the battery cells 36a-b to be displaced in the battery module compartment.

FIG. 4 shows a further exemplary embodiment of a battery pack in schematic cross-section. The battery pack 50 has an at least partially resilient battery pack housing 52 having a battery pack compartment 54 in which battery modules 56a-c are arranged in receivers (not shown) provided therefor. The battery modules 56a-c can be configured, for example, like the battery modules shown in FIG. 1.

Above the battery modules 56a-c, the battery pack compartment 54 has an escape area 58, so that the battery modules 56a-c are spaced apart from the battery pack housing 52 in that direction. This escape area 58 ensures that, under the action of a great force, as in the event of a crash, and with the associated deformation of the battery module housing of the battery modules 56a-c, there is sufficient space into which, for example, a curved cover of the battery module housing can penetrate. In this manner, the battery module housing of the battery modules 56a-c is able to deform resiliently and the battery cells in the battery modules 56a-c are thus able to escape the force acting from outside, so that the maximum force acting on the battery cells, and accordingly the risk of damage to the battery cells, can be reduced.

Further examples of polycarbonate compositions which are particularly suitable for the production of battery module housings or battery pack housings or parts thereof are described in the following.

### Examples

### Component A-1

Linear polycarbonate based on bisphenol A having a relative solution viscosity of ηᵣₑₗ=1.28 measured in CH₂Cl₂ as solvent at 25° C. and a concentration of 0.5 g/100 ml.

### Component B-1:

Silicone-acrylate composite rubber having the following composition:

Polymethyl methacrylate/silicone rubber/acrylate rubber: 14/31/55 wt. %

### Component B-2:

Silicone-acrylate composite rubber having the following composition:

Polymethyl methacrylate/silicone rubber/acrylate rubber 11/82/7 wt. %

### Component B*:

ABS polymer, prepared by emulsion polymerisation of 43 wt. % (based on the ABS polymer) of a mixture of 27 wt. % acrylonitrile and 73 wt. % styrene in the presence of 57 wt. % (based on the ABS polymer) of a particulate crosslinked polybutadiene rubber (mean particle diameter d₅₀=0.35 μm), wherein the graft polymer comprises approximately 15% free, soluble SAN. The gel content is 72%.

### Component C:

Bisphenol A-based oligophosphate (Reofoss BAPP) according to formula (Via)

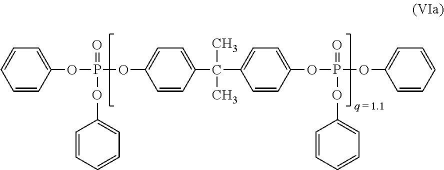

### Component D:

Polytetrafluoroethylene powder, CFP 6000 N, Du Pont.

### Component F:

F-1: Pentaerythritol tetrastearate as lubricant/demoulding agent

F-2: Phosphite stabiliser, phosphite stabiliser, Irganox® B900 (mixture of 80% Irgafos@168 and 20% Irganox® 1076; BASF AG; Ludwigshafen/Irgafos@168 (tris(2,4-di-tert-butyl-phenyl) phosphite)/Irganox@1076 (2,6-di-tert-butyl-4-(octadecanoxycarbonylethyl)phenol).

The substances listed in Table 1 are compounded and granulated in a twin-screw extruder (ZSK-25) (Werner und Pfleiderer) at a speed of 225 rpm and a throughput of 20 kg/h at a machine temperature of 260° C. The finished granules are processed to the corresponding test specimens in an injection-moulding machine (melt temperature 240° C., tool temperature 80° C., flow front speed 240 mm/s).

In the same manner, the substances listed in Table 2 are compounded and granulated in a twin-screw extruder (ZSK-25) (Werner und Pfleiderer) at a speed of 225 rpm and a throughput of 20 kg/h at a machine temperature of 260° C. The finished granules are processed to the corresponding test specimens in an injection-moulding machine (melt temperature 240° C., tool temperature 80° C., flow front speed 240 mm/s).

The following methods were used to characterise the properties of the test specimens: The flowability was determined in accordance with ISO 11443 (melt viscosity).

The notched Impact strength ak was measured in accordance with ISO 180/1A on a test rod, gated on one side, measuring 80×10×4 mm at the indicated measuring temperatures. The heat distortion resistance was measured in accordance with DIN ISO 306 (Vicat softening temperature, method B with 50 N load and a heating rate of 120 K/h) on a test rod, gated on one side, measuring 80×10×4 mm.

The behaviour in fire is measured in accordance with UL 94V on rods measuring 127×12.7×1.5 mm.

The elongation at break and tensile modulus of elasticity were measured in accordance with DIN EN ISO 527 on rods measuring 170.0×10.0×4.0 mm.

Under resistance to chemicals (ESC behaviour), the time is given to fracture at 2.4% outer fibre strain after storage of the test specimen in the indicated test substances at room temperature on a test rod, gated on one side, measuring 80×10×4 mm.

TABLE 1
Compositions and their properties

| | | 1 | 2 | 3 | 4 |
|---|---|---|---|---|---|
| Components | wt. % | | | | |
| A1 | | 84.10 | 78.10 | 84.10 | 78.10 |
| B1 | | | | 9.00 | 11.00 |
| B2 | | 9.00 | 11.00 | | |
| C | | 6.00 | 10.00 | 6.00 | 10.00 |
| D | | 0.40 | 0.40 | 0.40 | 0.40 |
| F1 | | 0.40 | 0.40 | 0.40 | 0.40 |
| F2 | | 0.10 | 0.10 | 0.10 | 0.10 |
| Total | | 100.00 | 100.00 | 100.00 | 100.00 |
| Properties | Units | | | | |
| ak ISO 180/1A at RT | [kJ/m²] | 59 | 57 | 60 | 58 |
| ak ISO 180/1A at | [kJ/m²] | 45 | 42 | 42 | 37 |
| −20° C. | | | | | |
| ak ISO 180/1A at | [kJ/m²] | 32 | 30 | 20 | 18 |
| −40° C. | | | | | |
| Vicat B 120 | [° C.] | 120 | 109 | 120 | 109 |
| UL 94 V/1.5 mm | | V-0 | V-0 | V-0 | V-0 |
| Afterburn time | [s] | 10 | 12 | 20 | 16 |
| Melt viscosity 260° C./ | [Pas] | 370 | 297 | 366 | 292 |
| 1000 s−1 | | | | | |
| ESC at 2.4% toluene/ | h:min | 14:08 | 30:00 | 7:00 | 14:36 |
| isopropanol (60:40) | | | | | |
| ESC at 2.4% rape oil | h:min | 7:45 | 2:45 | 7:00 | 2:39 |
| ESC at 2.4% glycol/ | h:min | 125:50 | 124:00 | 122:20 | 67:00 |
| water (50:50) | | | | | |
| ESC at 2.4% hydraulic | h:min | 168:00 | 168:00 | 168:00 | 168:00 |
| oil | | | | | |
| Tensile modulus of | N/mm² | 2248 | 2258 | 2242 | 2263 |
| elasticity | | | | | |
| Elongation at break | % | 106 | 110 | 103 | 110 |

TABLE 2
Compositions and their properties

| | | 5 | 6 |
|---|---|---|---|
| Components | wt. % | | |
| A1 | | 84.10 | 78.10 |
| B* | | 9.00 | 11.00 |
| C | | 6.00 | 10.00 |
| D | | 0.40 | 0.40 |
| F-1 | | 0.40 | 0.40 |
| F-2 | | 0.10 | 0.10 |
| Total | | 100.00 | 100.00 |
| Properties | Units | | |
| ak ISO 180/1A at RT | [kJ/m²] | 52 | 57 |
| ak ISO 180/1A at −20° C. | [kJ/m²] | 34 | 33 |
| ak ISO 180/1A at −40° C. | [kJ/m²] | 18 | 17 |
| at joint line | [kJ/m²] | 74 | 73 |
| Vicat B 120 | [° C.] | 120 | 110 |
| UL 94 V/1.5 mm | | V-1 | V-1 |
| Afterburn time | [s] | 54 | 50 |
| UL 94 V/2.5 mm | | V-0 | V-0 |
| Afterburn time | [s] | 15 | 11 |
| Melt viscosity | | | |
| 260° C./1000 s−1 | [Pas] | 415 | 319 |
| ESC at 2.4% toluene/isopropanol | h:min | 2:42 | 4:01 |
| ESC at 2.4% rape oil | h:min | 3:57 | 2:05 |
| ESC at 2.4% glycol/water (50:50) | h:min | 108:00 | 149:00 |
| ESC at 2.4% hydraulic oil | h:min | 168:00 | 168:00 |
| Elongation at break | % | | |
| Tensile modulus of elasticity | N/mm² | 2340 | 2350 |

Toluene/isopropanol mixture: 60/40 wt. %

Tests have shown that, with the above-mentioned polycarbonate compositions, it is possible to produce battery module housings which have at least partially a modulus of elasticity of not more than 80,000 N/mm², in particular of not more than 30,000 N/mm², or have at least partially a normalised rigidity of less than 140,000 Nmm², preferably less than 50,000 Nmm², in particular less than 25,000 Nmm².

1.-19. (canceled)

20. A Battery module,
having a battery module housing,
wherein the battery module housing encloses a battery module compartment and
wherein the battery module housing has on the battery module compartment side receivers for a specified number of battery cells,
wherein
the battery module has in the battery module compartment, in addition to the receivers, an escape area which is of such a size and is so arranged that at least one battery cell received in a receiver is displaceable at least partially into the escape area.

21. The battery module according to claim 20,
wherein
the battery module housing is at least partially resilient, preferably having a modulus of elasticity of not more than 80,000 N/mm².

22. The battery module according to claim 20,
wherein
the battery module housing has at least partially a normalised rigidity of less than 50,000 Nmm².

23. The battery module according to claim 20,
wherein
a resilient element is arranged in the escape area.

24. The battery module according to claim 23,
wherein
the resilient element is connected to the battery module housing by a form-, force- and/or material-based connection.

25. Battery module according to claim 24,
wherein
the resilient element is injection moulded with the battery module housing.

26. The battery module according to claim 20,
wherein
at least one receiver for a battery cell is formed at least partially by a depression in the battery module housing.

27. The battery module according to claim 20,
wherein
at least one receiver for a battery cell is formed at least partially by a collar element fixed to the battery module housing.

28. Battery module according to claim 20,
wherein
the battery module housing and/or a resilient element arranged in the escape area comprises a flame-retardant material, in particular a flame-retardant plastic.

29. The battery module according to claim 20,
wherein
the battery module housing comprises a polycarbonate material.

30. The battery module according to claim 29,
wherein
the polycarbonate material contained in the battery module housing is a polycarbonate composition which comprises the following components A+B+C or A+B*+C and in each case optionally components D, E and/or F in the amounts indicated in each case:
A) from 70.0 to 90.0 parts by weight (based on the sum of the parts by weight of components A+B+C or A+B*+C) of linear and/or branched aromatic polycarbonate and/or aromatic polyester carbonate,
B) from 6.0 to 15.0 parts by weight (based on the sum of the parts by weight of components A+B+C) of at least one graft polymer having
B.1) from 5 to 40 wt. %, preferably from 5 to 30 wt. %, particularly preferably from 10 to 20 wt. % (in each case based on the graft polymer B) of a shell of at least one vinyl monomer, and
B.2) from 95 to 60 wt. %, preferably from 95 to 70 wt. %, particularly preferably from 80 to 90 wt. % (in each case based on the graft polymer B) of one or more graft bases of silicone-acrylate composite rubber,
B*) from 6.0 to 15.0 parts by weight (based on the sum of the parts by weight of components A+B*+C) of at least one graft polymer having
B*.1) from 5 to 95 parts by weight, preferably from 30 to 80 parts by weight, of a mixture of
B*.1.1) from 50 to 95 parts by weight of styrene, α-methylstyrene, styrene methyl-substituted on the ring, C1-C8-alkyl methacrylate, in particular methyl methacrylate, C1-C8-alkyl acrylate, in particular methyl acrylate, or mixtures of these compounds, and
B*.1.2) from 5 to 50 parts by weight of acrylonitrile, methacrylonitrile, C1-C8-alkyl methacrylates, in particular methyl methacrylate, C1-C8-alkyl acrylate, in particular methyl acrylate, maleic anhydride, C1-C4-alkyl- or -phenyl-N-substituted maleimides or mixtures of these compounds on
B*.2) from 5 to 95 parts by weight, preferably from 20 to 70 parts by weight, of a rubber-containing graft base based on butadiene or acrylate,
C) from 2.0 to 15.0 parts by weight (based on the sum of the parts by weight of components A+B+C or A+B*+C) of phosphorus compounds selected from the groups of the monomeric and oligomeric phosphoric and phosphonic acid esters, phosphonate amines, phosphazenes and phosphinates, as well as mixtures of these compounds,
D) from 0 to 3.0 parts by weight (based on the sum of the parts by weight of components A+B+C or A+B*+C) of antidripping agents,
E) from 0 to 3.0 parts by weight (based on the sum of the parts by weight of components A+B+C or A+B*+C) of thermoplastic vinyl (co)polymer (E.1) and/or polyalkylene terephthalate (E.2), and
F) from 0 to 20.0 parts by weight (based on the sum of the parts by weight of components A+B+C or A+B*+C) of further additives,
wherein the compositions are preferably free of rubber-free polyalkyl (alkyl)acrylate, and wherein all part by weight data in the present application are so normalised that the sum of the parts by weight of components A+B+C or A+B*+C in the composition is 100.

31. The battery module according to claim 20,
wherein
the battery module comprises the specified number of battery cells, wherein the individual battery cells are received in the receivers.

32. A battery pack,
having a battery pack housing,
wherein the battery pack housing encloses a battery pack compartment and
wherein the battery pack housing has on the battery pack compartment side at least one receiver for a battery module,
wherein
the battery pack has a battery module according to claim 20 received in the receiver.

33. The battery pack according to claim 32,
wherein
the battery pack housing has at least partially a modulus of elasticity of not more than 80,000 N/mm².

34. The battery pack according to claim 32,
wherein
the battery pack housing has at least partially a normalised rigidity of less than 140,000 Nmm².

35. The battery pack according to any claim 32,
wherein
the battery pack has an escape area in the battery pack compartment on at least one side of the battery module, so that the battery module is spaced apart from the battery pack housing and other battery modules in the battery pack on that side.

36. The battery pack according to claim 32,
wherein
the battery pack housing comprises a polycarbonate material.

37. The battery pack according to claim 36,
wherein
the polycarbonate material contained in the battery pack housing is a polycarbonate composition which comprises the following components A+B+C or A+B*+C and in each case optionally components D, E and/or F in the amounts indicated in each case:
A) from 70.0 to 90.0 parts by weight (based on the sum of the parts by weight of components A+B+C or A+B*+C) of linear and/or branched aromatic polycarbonate and/or aromatic polyester carbonate,
B) from 6.0 to 15.0 parts by weight (based on the sum of the parts by weight of components A+B+C) of at least one graft polymer having
B.1) from 5 to 40 wt. %, preferably from 5 to 30 wt. %, particularly preferably from 10 to 20 wt. % (in each case based on the graft polymer B) of a shell of at least one vinyl monomer, and
B.2) from 95 to 60 wt. %, preferably from 95 to 70 wt. %, particularly preferably from 80 to 90 wt. % (in each case based on the graft polymer B) of one or more graft bases of silicone-acrylate composite rubber,
B*) from 6.0 to 15.0 parts by weight (based on the sum of the parts by weight of components A+B*+C) of at least one graft polymer having
B*.1) from 5 to 95 parts by weight, preferably from 30 to 80 parts by weight, of a mixture of
B*.1.1) from 50 to 95 parts by weight of styrene, α-methylstyrene, styrene methyl-substituted on the ring, C1-C8-alkyl methacrylate, in particular methyl methacrylate, C1-C8-alkyl acrylate, in particular methyl acrylate, or mixtures of these compounds, and
B*.1.2) from 5 to 50 parts by weight of acrylonitrile, methacrylonitrile, C1-C8-alkyl methacrylates, in particular methyl methacrylate, C1-C8-alkyl acrylate, in particular methyl acrylate, maleic anhydride, C1-C4-alkyl- or -phenyl-N-substituted maleimides or mixtures of these compounds on
B*.2) from 5 to 95 parts by weight, preferably from 20 to 70 parts by weight, of a rubber-containing graft base based on butadiene or acrylate,
C) from 2.0 to 15.0 parts by weight (based on the sum of the parts by weight of components A+B+C or A+B*+C) of phosphorus compounds selected from the groups of the monomeric and oligomeric phosphoric and phosphonic acid esters, phosphonate amines, phosphazenes and phosphinates, as well as mixtures of these compounds,
D) from 0 to 3.0 parts by weight (based on the sum of the parts by weight of components A+B+C or A+B*+C) of antidripping agents,
E) from 0 to 3.0 parts by weight (based on the sum of the parts by weight of components A+B+C or A+B*+C) of thermoplastic vinyl (co)polymer (E.1) and/or polyalkylene terephthalate (E.2), and
F) from 0 to 20.0 parts by weight (based on the sum of the parts by weight of components A+B+C or A+B*+C) of further additives,
wherein the compositions are preferably free of rubber-free polyalkyl (alkyl)acrylate, and wherein all part by weight data in the present application are so normalised that the sum of the parts by weight of components A+B+C or A+B*+C in the composition is 100.

38. An electric vehicle,
wherein
the electric vehicle has a battery module according to claim 20.

39. An electric vehicle,
wherein the electric vehicle has a battery pack according to claim 32.
